(19) United States
(12) Patent Application Publication
(10) Pub. No.: US 2004/0181430 A1
(43) Pub. Date: Sep. 16, 2004

(54) Healthcare provider-patient online consultation and compliance program

(76) Inventors: Edward Fotsch, Sausalito, CA (US); Deb DelGuidice, Sausalito, CA (US); Leslie Yuan, San Francisco, CA (US)

Correspondence Address: BEYER WEAVER & THOMAS LLP, P.O. BOX 778, BERKELEY, CA, 94704-0778, US

(21) Appl. No.: 10/641,982

(22) Filed: Aug. 15, 2003

Related U.S. Application Data
(63) Continuation-in-part of application No. 10/387,041, filed on Mar. 10, 2003.

(51) Int. Cl. G06F 17/60

(52) U.S. Cl. 705/2

(57) ABSTRACT

Methods and apparatus for providing medical advice or medical information from a healthcare provider to a user (e.g., via the Internet) are disclosed. A compliance program may be selected from a plurality of compliance programs. The compliance program is associated with one or more users. Once associated with one or more users, the compliance program may be executed. Each compliance program includes one or more messages to be transmitted to the user when a condition associated with the corresponding message is satisfied. Each of the messages includes medical advice or medical information (e.g., corresponding to a medication or medical condition).

### RELATED APPLICATIONS

This application is a continuation-in-part of application Ser. No. 10/387,041, Attorney Docket No. MDM1P001, entitled “HEALTHCARE PROVIDER-PATIENT ONLINE CONSULTATION SYSTEM,” listing Fotsch et al. as inventors, filed on Mar. 10, 2003, which is incorporated herein by reference for all purposes.

### BACKGROUND OF THE INVENTION

1. Field of the Invention

The present invention relates to an online consultation and compliance system. More particularly, the present invention relates to physician-patient communications supporting online compliance programs via the Internet.

2. Description of the Related Art

Visiting the doctor is often a time-consuming endeavor, often requiring an individual to schedule his or her appointment weeks or months in advance. Even when an individual is feeling under the weather, he or she may feel that it is unnecessary to visit the doctor. For instance, the individual may merely wish to ask the doctor preliminary questions before making an appointment, or ask a simple medical question such as which over-the-counter medication is best for his or her ailment. As a result, the patient may feel it is unnecessary to take time out of his or her busy schedule, or take time off from work to receive such simple medical advice. It would therefore be desirable if interactive medical advice could be more accessible to patients.

There are also many instances when a person may wish to see their regular physician, but cannot do so for a variety of reasons. For instance, the person may be traveling or on vacation, and unwilling to seek the medical advice of a physician with whom they are unfamiliar, or who does not have access to their complete medical history. It would therefore be desirable if a person seeking medical advice could receive medical advice from their regular physician without visiting the physician's office or making an appointment to see their physician.

The Internet has recently become a popular information resource for even the most unsophisticated computer user. The popularity of the Internet as an information source is due, in part, to the vast amount of available information that can be downloaded by almost anyone having access to a computer and a modem. The Internet's strength also lies in its open-ended nature. These and other factors have caused an exponential increase in Internet usage and with it, an exponential increase in the volume of information available.

In the absence of a tool enabling direct online physician-patient communication, users have unilaterally searched for medical information on the Internet. While an enormous amount of information is available via the Internet on a wide variety of topics and ailments, the reliability and accuracy of this information is dubious at best. Moreover, even if the information is proved to be accurate, the user is left to self-diagnose or self-treat, potentially resulting in a misdiagnosis and therefore improper treatment.

Traditionally, physicians have only been paid for face-to-face time with their patients. With the advent of the Internet, many businesses have migrated their practices online. For instance, many retail businesses sell consumer goods via the Internet. While systems suitable for use in a variety of industries have been developed to support numerous online businesses, such systems are often insecure and not easily applicable to confidential communications such as physician-patient communications. Unfortunately, there fails to be an effective mechanism that enables physicians to communicate effectively and confidentially online with patients. It would therefore be desirable to leverage the power and accessibility of the Internet to facilitate the exchange of information among patients and physicians.

In view of the above, it would be beneficial if a system were developed to support physician-patient communications via the Internet.

### SUMMARY OF THE INVENTION

The present invention enables a user to receive medical information or advice from their healthcare provider via the Internet. This may be accomplished, for example, by submitting an online consultation request requesting medical information and/or medical advice. The healthcare provider may then send an online consultation reply to the patient via the Internet, providing the information the user requested in his or her online consultation request. In this manner, a patient may receive valuable medical information or advice from their healthcare provider via the Internet.

In accordance with one aspect of the invention, the disclosed embodiments are used to support communication between patients and a healthcare provider. For instance, a healthcare provider may be a healthcare provider authorized to practice medicine, such as a physician, nurse, physician's assistant, or nurse-practitioner. Other examples include chiropractors and optometrists. In addition, healthcare providers may include service providers, such as pharmacists and lab technicians, which provide services to primary healthcare providers such as physicians. A healthcare provider such as a physician's assistant need not be capable of practicing independently. Rather, they merely need to be subservient to a healthcare provider (e.g., physician) and working within the healthcare provider's practice group, where the healthcare provider is associated with the healthcare provider-controlled network. Thus, the healthcare provider may be sending a communication to a patient on behalf of a physician. In order to simplify the following description, a physician-patient system will be described. However, it will be understood that the disclosed system may also be used to support communication between patients and healthcare providers other than physicians.

In accordance with one aspect of the invention, the patient accesses a specific physician's web site in order to send an online consultation request. For instance, a current patient of the physician may wish to send an online consultation request regarding a current medical problem. Of course, it is important to note that the online consultation request may also be sent by a user to a healthcare provider or to a service enabling one of a number of healthcare providers to answer the online consultation request. Thus, while it may be desirable for physicians to limit their online consultation practice to current patients, it may also be possible to provide limited medical advice to individuals who the physician has not previously seen (e.g., such as where the physician is in a medical group in which the patient's physician is a member). Moreover, some individuals may prefer to send medical questions anonymously to a physician or group of physicians, rather than to their personal physician. This may be possible, for instance, by accessing a web site supporting a number of physicians, or sending a message via a secure messaging system, or other communication schemes.

In accordance with another aspect of the invention, in response to the online consultation request, the physician may decline the request or accept the request by sending an online consultation reply message. For instance, the physician may wish to decline responding if the user is not a current patient of the physician. This therefore enables a physician to decide to respond to those online consultation requests for which he or she has adequate medical knowledge and medical history to answer the question accurately.

In accordance with another aspect of the invention, when an online consultation reply message is sent to the user, the user receives a notification message (e.g., via regular e-mail) indicating that the user has an online consultation reply message waiting to be read. The user then accesses the reply message via the physician's web site. This may be accomplished by entering a username and password established during registration with the physician's web site. Through the use of a web site to access online consultation messages, the security and privacy of the medical advice remains confidential and secure. Alternatively, other types of secure messaging or e-mail systems may be used to implement the present invention. In this manner, a secure environment that includes a requirement for authentication such as a web site enables online consultation messages to be sent as well as accessed.

In accordance with yet another aspect of the invention, registration may be required via the physician's web site in order to obtain the necessary identifying information for the patient. Moreover, registration may also serve as a request for access by the patient to online consultation services. In other words, the registration message(s) may serve as a request to enable the user/patient to send one or more messages to the physician via the Internet, as well as receive one or more messages from the physician via the Internet. The physician may therefore wish to accept or decline these services to a specific individual. Moreover, the physician may wish to provide only specific messaging services to an individual, such as prescription renewal, new prescription, appointment reminder, and prescription compliance messages. In addition, registration may serve to establish a username and password to enable the user to access his or her online messages from a physician via the physician's web site.

In accordance with yet another aspect of the invention, each compliance program may have different features. For instance, each compliance program may include different messaging content and number of messages. Thus, the number and content of the messages may be modified for programs that are not “read only” (e.g., send only) programs. In addition, conditions triggering the transmission of messages may be edited. Moreover, a compliance program may be initiated or disabled (e.g., cancelled) by the healthcare provider or the user (e.g., where the healthcare provider has enabled such user options).

In accordance with yet another aspect of the invention, a compliance program may be selected from a plurality of compliance programs. The compliance program is then associated with one or more users. Once associated with one or more users, the compliance program may be executed. Each compliance program includes one or more messages to be transmitted to the user when a condition associated with the corresponding message is satisfied, where each of the messages includes medical advice or medical information (e.g., corresponding to a medication or medical condition) to be provided to the receiving user.

These and other features of the present invention will be described in more detail below in the detailed description of the invention and in conjunction with the following figures.

### BRIEF DESCRIPTION OF THE DRAWINGS

FIG. 1 is an exemplary graphical user interface illustrating services available to a physician via the physician's web site in accordance with various embodiments of the invention.

FIGS. 2-4 together illustrate an exemplary graphical user interface used by a physician to set up or modify his or her online consultation practice in accordance with various embodiments of the invention.

FIGS. 5-6 together illustrate an exemplary graphical user interface used by a physician to set up or modify his or her mailbox settings to support online consultation and patient-physician messaging in accordance with various embodiments of the invention.

FIG. 7 is an exemplary graphical user interface used to support mailbox services, patient messaging and online consultation messaging access by physician practice members in accordance with various embodiments of the invention.

FIG. 8 is an exemplary graphical user interface enabling a physician to print pending online consultations received in his or her mailbox in accordance with various embodiments of the invention.

FIG. 9 is an exemplary graphical user interface enabling a physician to access his or her online consultation inbox in accordance with various embodiments of the invention.

FIG. 10 is an exemplary graphical user interface visible to patients accessing the physician's web site in accordance with various embodiments of the invention.

FIGS. 11-12 together illustrate an exemplary graphical user interface enabling new patients to register with their physician to receive online messaging services in accordance with various embodiments of the invention.

FIG. 13 is an exemplary graphical user interface used by a physician to access new patient registrations in accordance with various embodiments of the invention.

FIG. 14 is an exemplary graphical user interface used by a physician to grant messaging privileges associated with a patient registration and associated messaging privileges request in accordance with various embodiments of the invention.

FIG. 15 is an exemplary graphical user interface used by a user to send and access messages in accordance with various embodiments of the invention.

FIGS. 16-17 together illustrate an exemplary graphical user interface used by a user to generate an online consultation request in accordance with various embodiments of the invention.

FIG. 18 is an exemplary graphical user interface presented to a user to authorize the charge for the online consultation request in accordance with various embodiments of the invention.

FIG. 19 is an exemplary graphical user interface presented to the user upon transmitting the online consultation request to the physician in accordance with various embodiments of the invention.

FIG. 20 is an exemplary graphical user interface presented to the physician to enable the physician to access online consultation requests in his or her online consultation inbox in accordance with various embodiments of the invention.

FIG. 21 is an exemplary graphical user interface illustrating an online consultation request received by the physician in accordance with various embodiments of the invention.

FIGS. 22-23 together illustrate an exemplary graphical user interface for generating an online consultation reply message in accordance with various embodiments of the invention.

FIG. 24 is an exemplary graphical user interface presented to the physician upon transmitting the online consultation reply to the patient in accordance with various embodiments of the invention.

FIG. 25 is an exemplary graphical user interface enabling a physician to access his or her sent online consultation reply messages in accordance with various embodiments of the invention.

FIG. 26 is an exemplary graphical user interface presented to the user enabling the user to access online consultation reply messages in accordance with various embodiments of the invention.

FIG. 27 is a process flow diagram presenting an overview of the online consultation process in accordance with various embodiments of the invention.

FIG. 28 is an exemplary graphical user interface presented to the user upon initiation of a compliance program by a healthcare provider in accordance with various embodiments of the invention.

FIG. 29 is an exemplary graphical user interface presented to a user at the end of the first week of a drug therapy in accordance with various embodiments of the invention.

FIG. 30 is an exemplary graphical user interface presented to a user at the end of the fourth week of a drug therapy in accordance with various embodiments of the invention.

FIG. 31 is a diagram illustrating an exemplary system in which the present invention may be implemented.

### DETAILED DESCRIPTION OF THE INVENTION

In the following description, numerous specific details are set forth in order to provide a thorough understanding of the present invention. It will be obvious, however, to one skilled in the art, that the present invention may be practiced without some or all of these specific details. In other instances, well known process steps have not been described in detail in order not to unnecessarily obscure the present invention.

The present invention supports secure online healthcare provider-patient consultation requests via the Internet. In this example, the healthcare provider is a physician. Thus, the following example will refer to physician-patient communications. The terms user and patient will be used interchangeably herein. However, it is important to note that a user need not be a pre-existing patient of a physician in order to seek medical information or advice from the physician. Of course, the physician may choose to decline his or her online consultation services to a user who is not a pre-existing patient of the physician.

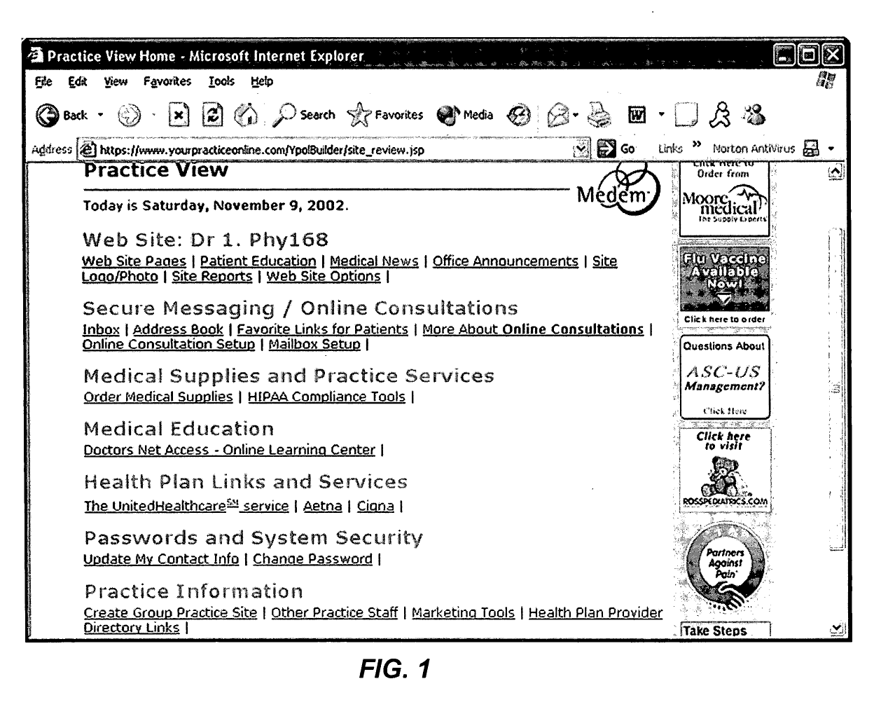

In the following described embodiments, the physician offers his or her online consultation services through a web site associated with the physician. FIG. 1 is an exemplary graphical user interface illustrating services available to a physician in accordance with various embodiments of the invention. Through a third-party service, a plurality of physician web sites are supported. Through the physician's “practice view” or single point of access, the physician may access practice information, health plan hypertext links and services, medical education services, medical supplies and practice services, secure messaging services and compliance programs. Secure messaging may enable a physician and a user (e.g., patient) to communicate with one another for a variety of reasons. For this purpose, multiple types of messages are available to the physician and user, including an online consultation message, appointment request, and prescription refill request. In order to enable a user to access the physician's online consultation messaging services, the physician first sets up his or her preferences and contact information for billing purposes by clicking on the “Online Consultation Setup” hypertext link.

In order to personalize his or her online consultation practice, the physician can establish various online consultation practice settings, as will be described in further detail below. For instance, the physician may wish to establish a maximum fee, establish online consultation messaging access for specific practice members, and enable or prevent users from transmitting various types of online messages, such as prescription refill requests or online consultation requests. Once configured, these online consultation practice settings may subsequently be modified by the physician as the physician deems appropriate for his or her online consultation practice.

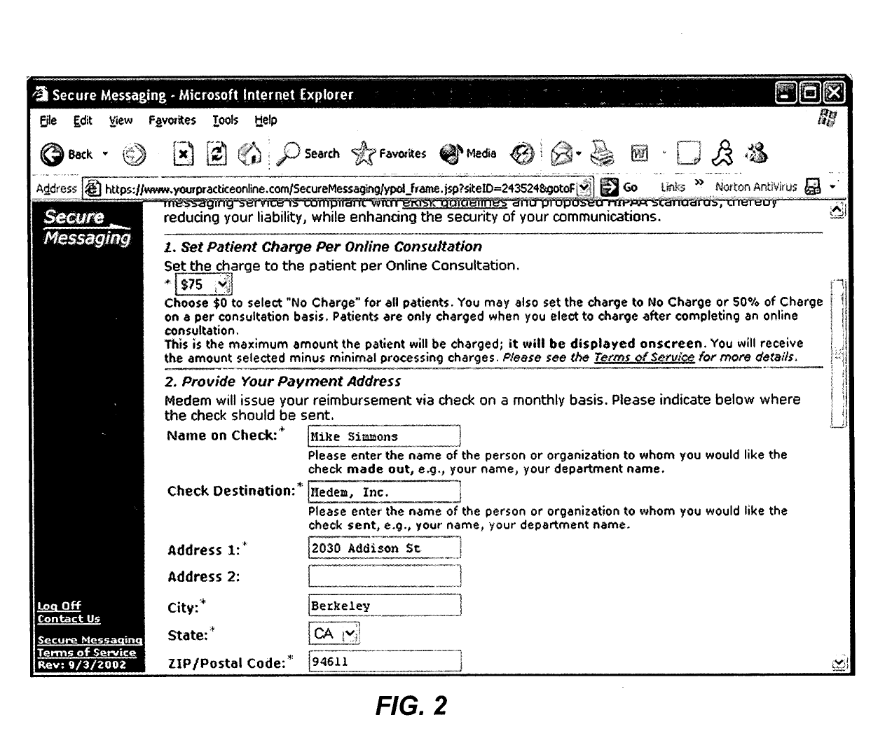

FIGS. 2-4 together illustrate an exemplary graphical user interface used by a physician to set up or modify his or her online consultation practice in accordance with various embodiments of the invention. As shown in FIG. 2, the physician may establish the maximum charge for an online consultation. Of course, as will be described in further detail below, the physician may choose to charge a reduced fee (or no fee) for specific patients as well as specific online consultations. For instance, a patient may be a low-income patient. The physician may therefore wish to charge a specified percentage of the maximum pre-established fee. As another example, an online consultation may involve a simple medical question that the physician does not feel justifies a charge to the patient. However, by establishing the maximum fee, the user transmitting the online consultation request is given the proper notice of the possible charge he or she may incur.

In accordance with one embodiment, the online consultation services are supported by a third-party service that receives a specified fee for this service. For instance, the third-party service may receive a percentage of each online consultation fee. Alternatively, the third-party service may receive a monthly or annual subscription fee and/or a set amount per consultation. Any transactional fees such as insurance company fees or credit card company fees are deducted, and the remaining fee amount is sent to the physician. The physician therefore submits his or her name and a payment address at which payment for the online consultation is to be received from the third-party service. As set forth above, the online consultation amount eventually charged to the user-patient may be established by the physician (e.g., at the time of submitting the online consultation reply).

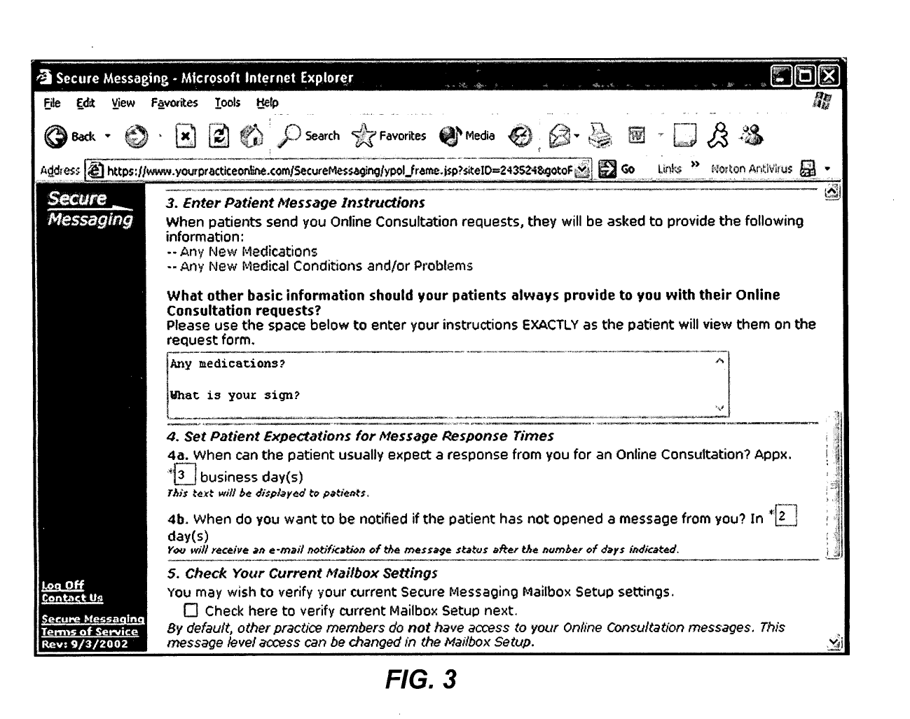

As shown in FIG. 3, during set up of his or her online consultation practice, the physician may also specify one or more questions (e.g., to be provided in the online consultation request message) to be answered by the patient in the online consultation request message prior to sending the online consultation request message to the physician via the Internet. For instance, the physician may wish to ask the patient if they have any allergies.

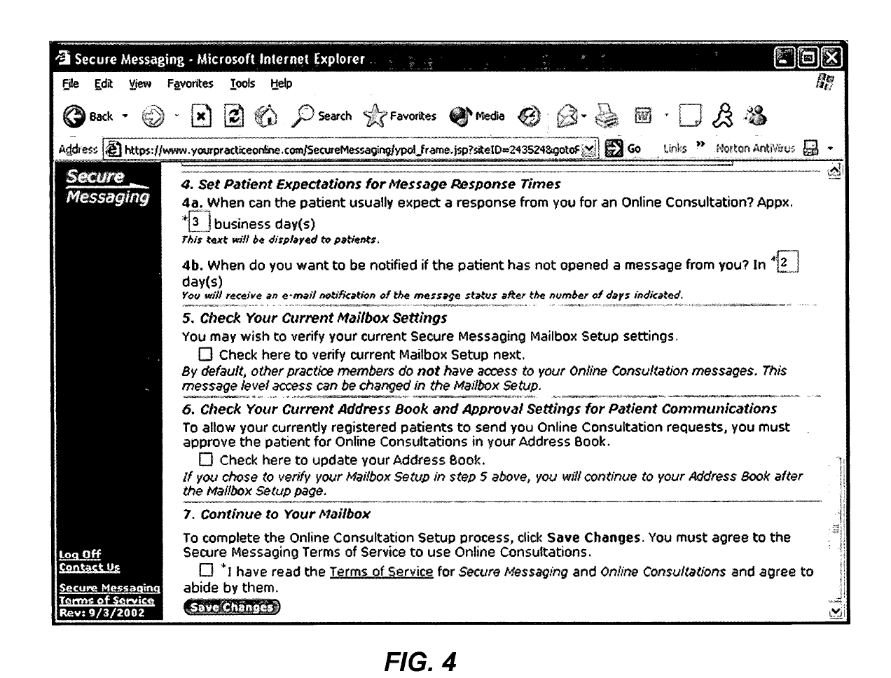

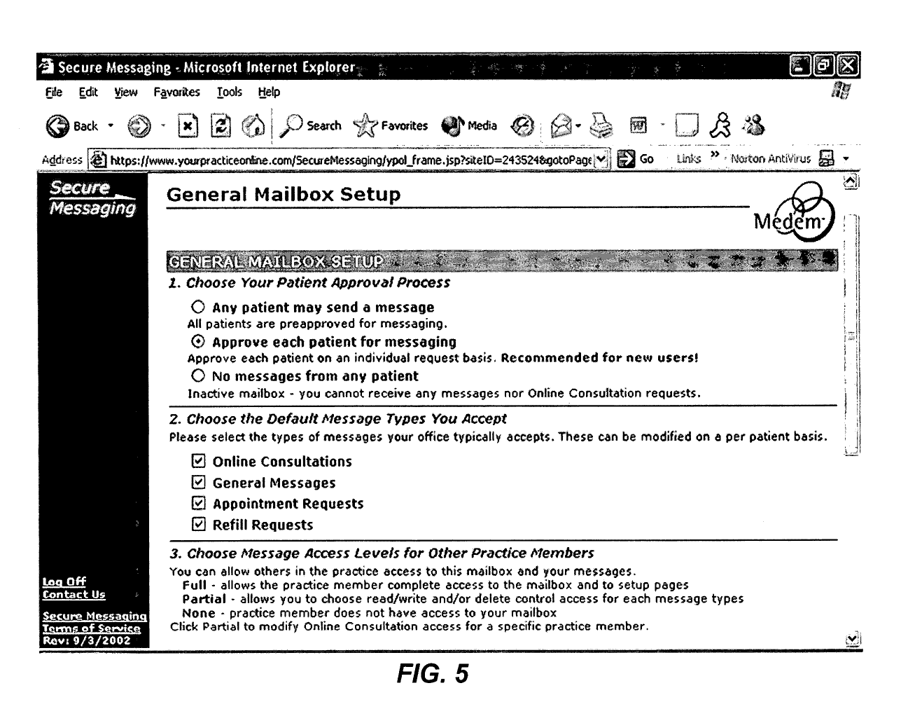

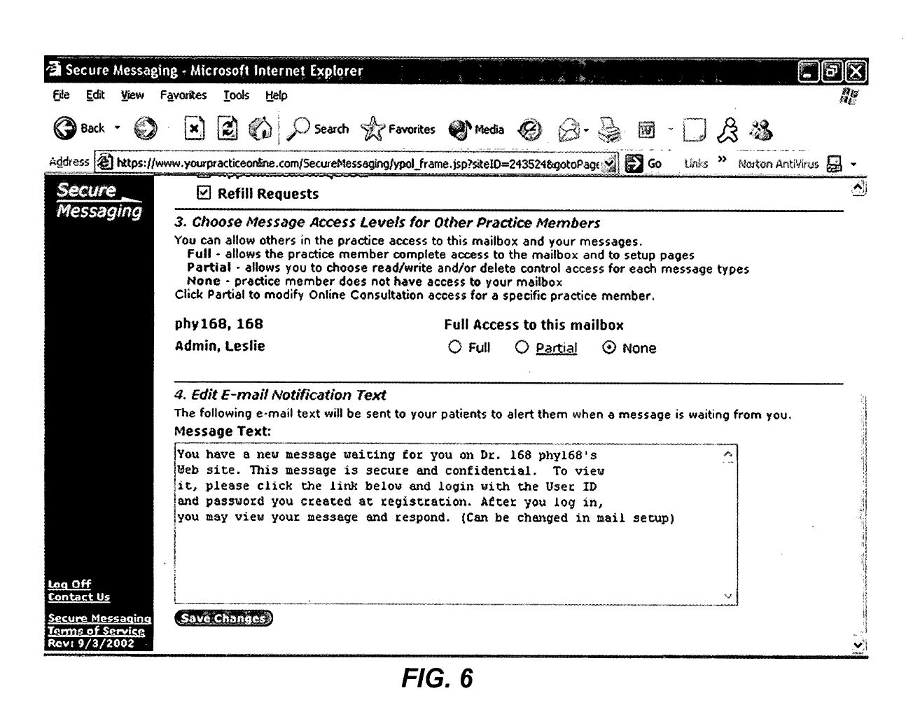

It may also be desirable to advise the patient as to the probable time it will take for the physician to respond to the medical inquiry. The physician may therefore specify an amount of time by which the patient can expect to receive a response from the physician in response to an online consultation request message. Similarly, the physician may also wish to be notified if the patient has not opened the online consultation reply message within a specified period of time. The physician may therefore specify an amount of time by which a notification message is to be sent to the physician when the patient has not opened an online consultation reply message sent by the physician in response to the online consultation request message within that amount of time. For instance, an automated message may be sent to the physician's e-mail address. In this manner, the physician completes his or her online consultation set up as shown in FIG. 4. For instance, the physician may check his or her mailbox settings and/or modify approval settings for patient communications. The physician then reads and accepts the Terms of Service, agreeing to abide by the Terms of Service provided to the physician. In order to complete the configuration for receiving and transmitting online consultation messages, the physician sets up his or her mailbox, as shown in FIGS. 5-6.

FIGS. 5-6 together illustrate an exemplary graphical user interface used by a physician to set up or modify his or her mailbox settings to support online consultation and patient-physician messaging in accordance with various embodiments of the invention. As shown in FIG. 5, the physician may select his or her patient approval process. Specifically, the physician may pre-approve all patients for online messaging. In this manner, the physician can enable messages such as patient registration messages and online consultation request messages to be received from any patient. Alternatively, the physician may require that each patient be individually approved for messaging on an individual request basis. As will be described in further detail below with respect to patient registration, a patient may be individually approved for one or more message types, including but not limited to, online consultation, appointment request, prescription renewal, appointment reminder, and compliance messages. A compliance message may be defined as a message that is sent to patients taking a specific drug or has a specific disease state. The prescription compliance message may be used to communicate information regarding the drug such as side-effects, refill-reminders, or other drug-related messages such as warnings or drug interaction or disease state. Of course, it may be desirable to configure an inactive mailbox, in which online messaging is not enabled for any patients. For instance, the physician may wish to configure the mailbox as inactive when the physician is on vacation or otherwise unavailable.

In addition, the physician may choose the default message types that are accepted by the physician. Default message types include, but are not limited to, online consultations, general messages, appointment requests, and refill requests. These configurations may be further modified on a per patient basis during the registration process, as will be described in further detail below.

As shown in FIG. 6, the physician may choose message access levels for other practice members associated with the physician. For instance, the physician may wish different members of his or her practice to have varying levels of access to patient information, as well as patient online messages such as registration and/or online consultation messages, including those received and transmitted by the physician. Thus, the physician may select a message access level indicating a level of access to messages including online consultation messages for various practice members. In this example, the level of access may be full, partial, or none. The level of access indicates whether the individual has read, write, reply and/or delete control access. Full access allows the practice member(s) complete access to the mailbox and setup pages, including read, write, reply and delete control access. Partial access enables the physician to enable a practice member to have limited access to physician-patient online messages. For instance, the physician may choose to enable read, write, reply and/or delete control access for a particular practice member. In addition, the control access selection may be further designated for each message type. As shown in this example, the administrative assistant is given no access to the mailbox. The physician may further provide message text that will be sent to patients via their email address to alert them when a message is waiting from the physician at the physician's website.

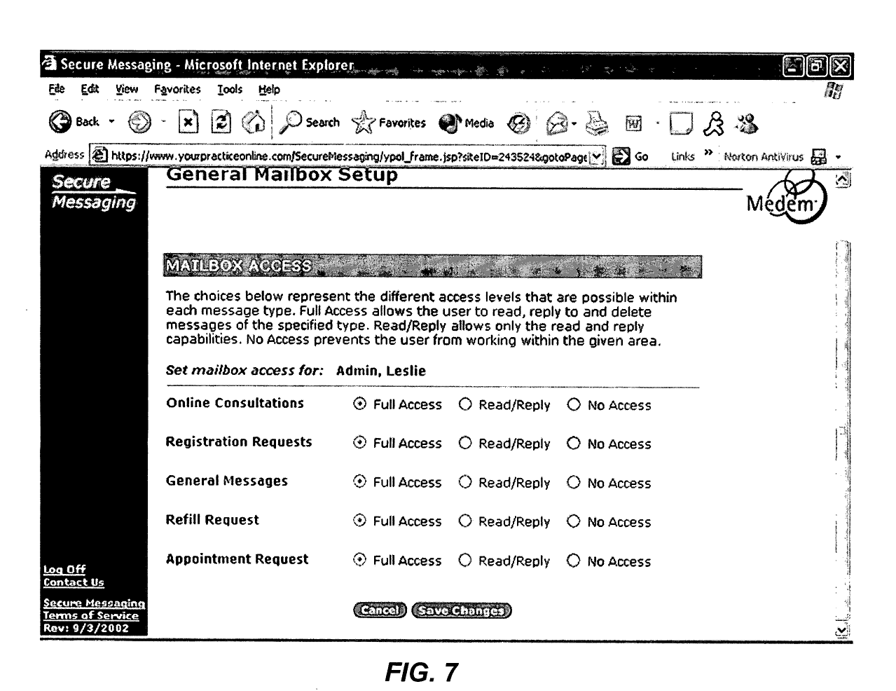

FIG. 7 is an exemplary graphical user interface used to support mailbox services, patient messaging and online consultation messaging access by physician practice members in accordance with various embodiments of the invention. As described above, a practice member may be assigned a message access level indicating a level of access (e.g., full, partial, or none). Partial access may indicate, for example, read and reply access, but not write or delete access. In this example, the message access level is further associated with the type of message. Thus, the practice member is actually assigned multiple message access levels corresponding to the multiple message types. Exemplary message types include online consultation, registration request, general message, refill request, and appointment request.

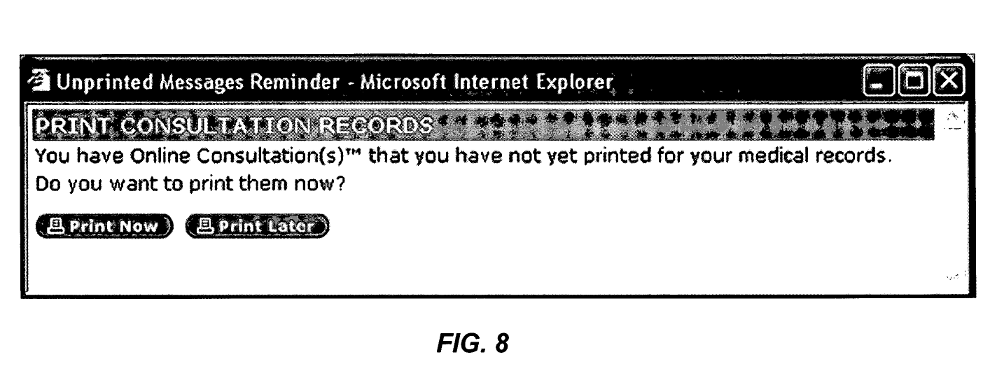

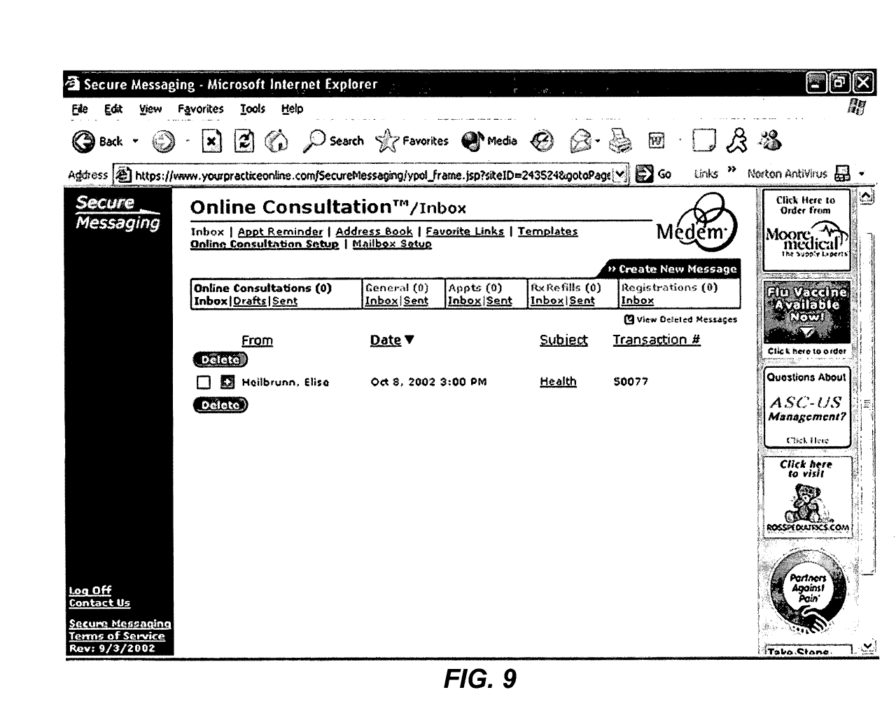

After setting up the physician's mailbox, the physician may receive and access pending online consultation request messages. FIG. 8 is an exemplary graphical user interface enabling a physician to print pending online consultation messages received in his or her mailbox in accordance with various embodiments of the invention. As shown in this example, the physician may print online consultation messages (e.g., request and reply messages) for the patient's file. The physician may also choose to save any messages as text files. The physician may access all pending online consultations via his or her online consultation in-box, as will be described in further detail below with reference to FIG. 9.

FIG. 9 is an exemplary graphical user interface enabling a physician to access his or her online consultation inbox in accordance with various embodiments of the invention. As shown in this example, each online consultation request message identifies the sender, the date sent, the subject, and an associated transaction number. The physician may choose to delete the online consultation request message after the physician determines whether he wishes to respond to the message. For instance the physician may choose not to respond to the online consultation request message, or may choose to delete the message after sending an online consultation reply message.

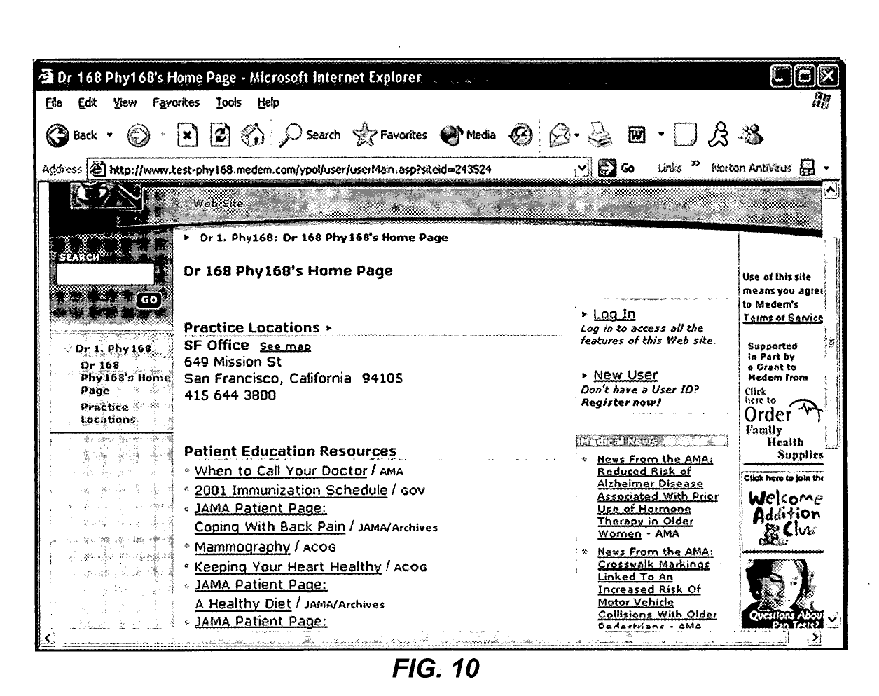

In order to illustrate the operation of the online consultation system, the user interface presented to the user-patient will now be described. FIG. 10 is an exemplary graphical user interface visible to patients accessing the physician's web site in accordance with various embodiments of the invention. The user may click on the “Log In” hypertext link to log in, or the “New User” hypertext link in order to register with the physician's web site as a new user. In accordance with the described embodiment, registration is performed to request permission to send and receive messages from a physician via the Internet.

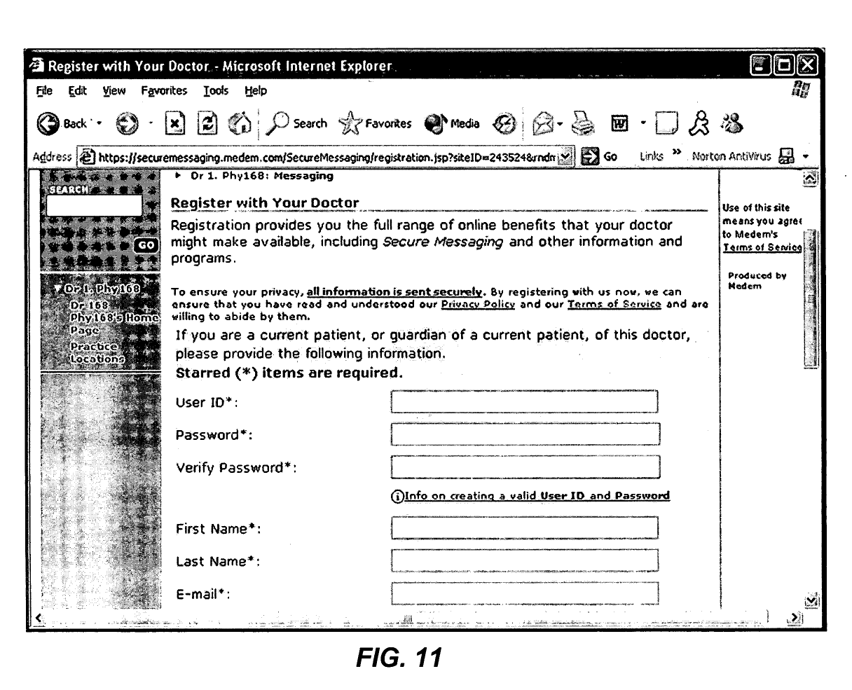

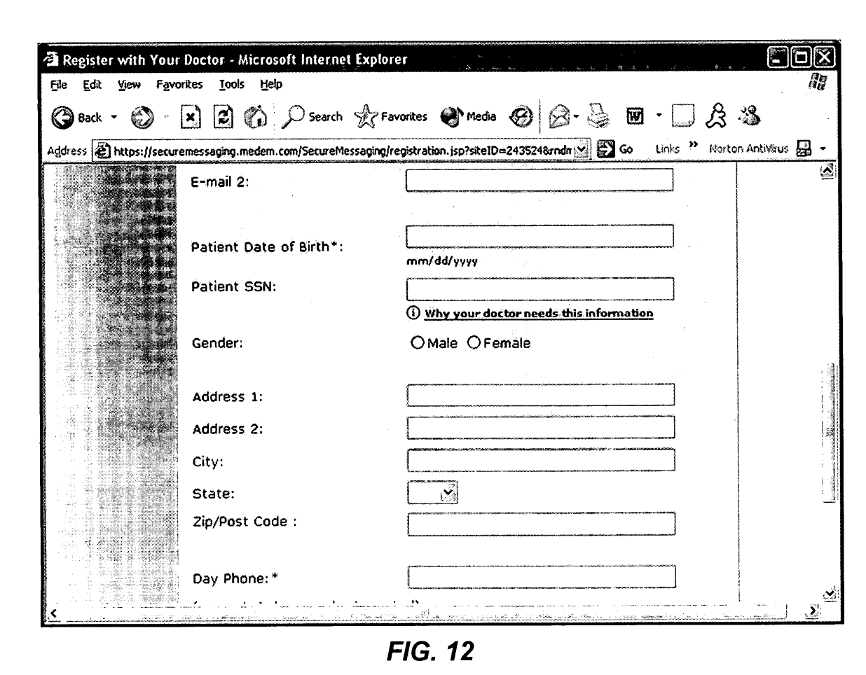

FIGS. 11-12 together illustrate an exemplary graphical user interface enabling new patients to register with their physician to receive online messaging services in accordance with various embodiments of the invention. As shown in FIG. 11, the user may register by entering identifying information such as first and last name. In addition, an e-mail address is entered in order to enable the patient to be notified of messages waiting for him or her at the physician's web site. For instance, the patient may receive notification of his or her registration, or denial of registration. In addition, the patient may receive notification that an online consultation reply message is waiting to be read by the user. Confidential health and medical information and advice may then be accessed via the web site using a user ID and password configured during registration. In this manner, the present invention provides a secure and confidential mechanism for providing medical information via the Internet. In alternative embodiments, communications may also be sent via the standard, non-secure e-mail address.

Additional identifying information may also be entered as shown in FIG. 12. For instance, this information may be used by a physician to enable the physician to accurately identify the patient prior to providing medical advice. The information may include, for example, date of birth, social security number, gender, address, and phone number. A second e-mail address may also be provided. From the registration information, a registration message is sent to the physician.

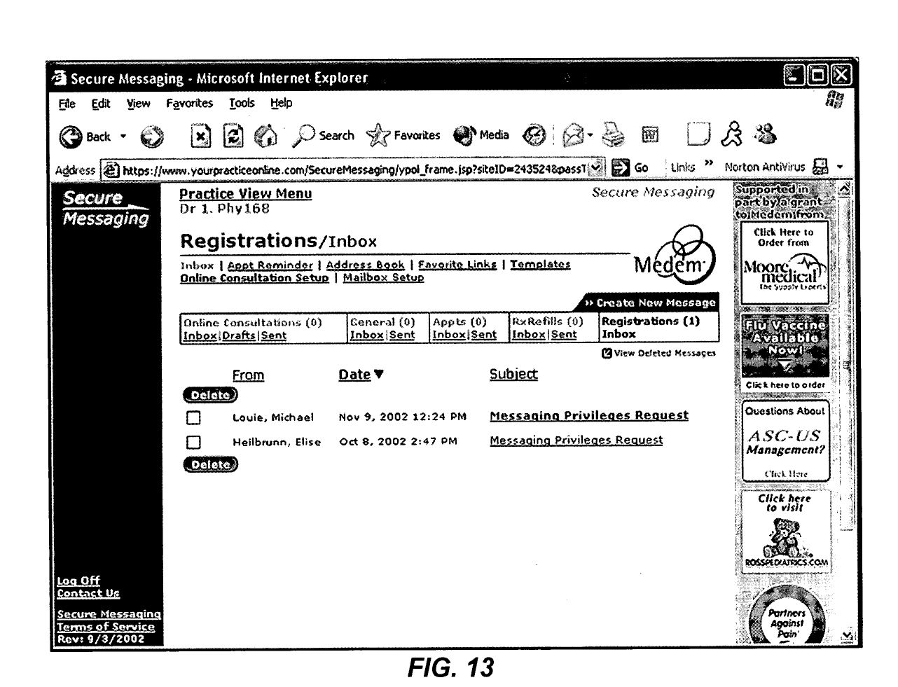

FIG. 13 is an exemplary graphical user interface used by a physician to access new patient registrations in accordance with various embodiments of the invention. In the registrations in-box, the physician may access registration messages (i.e., online message privilege requests), as shown. Each message may identify the sender, date, and subject of the message.

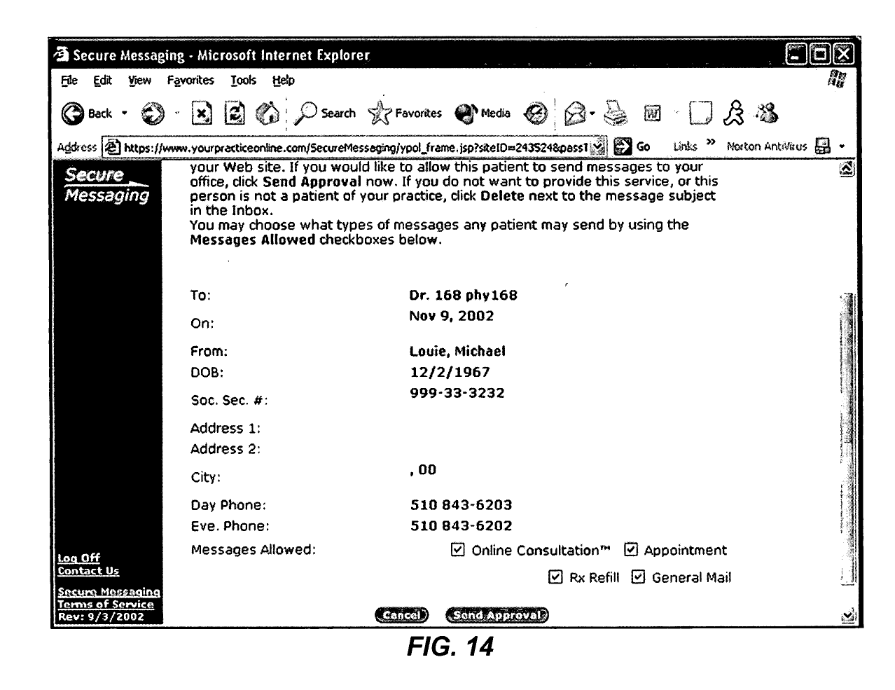

In accordance with one embodiment, the physician may accept or decline online message privilege requests. In this manner, the physician controls patient access to the network in which the physician's web site is a gateway. FIG. 14 is an exemplary graphical user interface used by a physician to grant messaging privileges associated with a patient registration and associated messaging privileges request in accordance with various embodiments of the invention. By opening a registration message, the physician may accept the registration or decline the registration. The physician may decline registration simply by deleting the registration request. Alternatively, the physician may accept the registration by sending an approval notification message. Once registration is approved and the user has been granted privileges for online consultation, the user can send messages such as online consultation request messages to the physician, as well as receive messages such as online consultation reply messages from the physician. In alternative embodiments, registration is an automated process resulting in immediate approval of online registration messages.

As shown, the physician receives at least a portion of the registration information supplied by the patient during registration. For instance, the registration message received may include identifying information for the user-patient. However, the message will not include confidential information such as userId and password.

The physician can also select one or more message types that the patient can send to the physician (or receive) via the Internet. As described above, these message types may include online consultation, appointment, prescription renewal, and general mail (e.g., administrative question). Thus, the physician may modify the default settings the physician previously set as shown in FIG. 5 by indicating those message types that may be received from users on a per-patient basis.

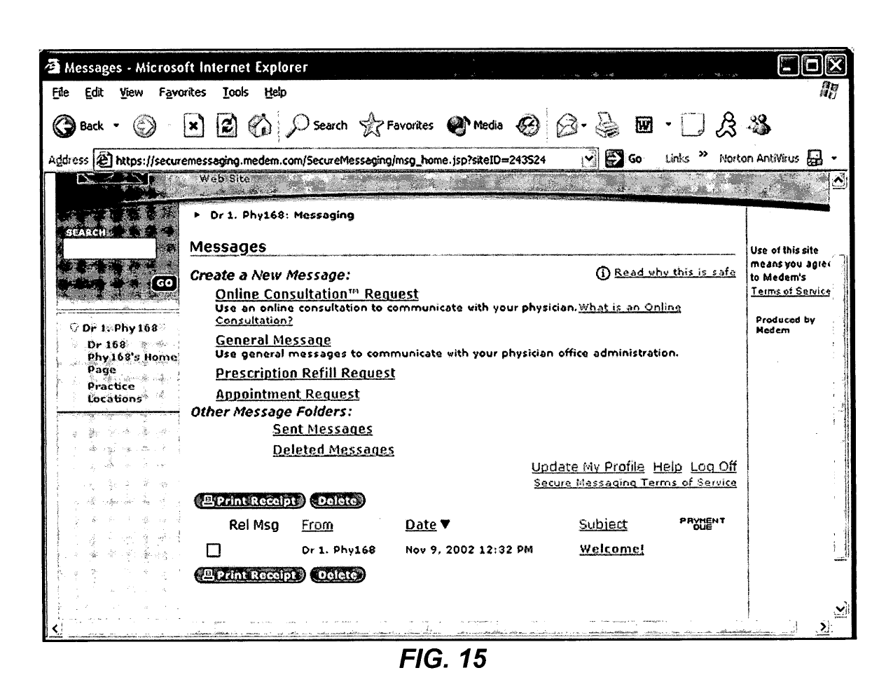

Once a user has successfully registered via a physician's web site, the user may then send messages such as online consultation requests to the physician via that web site. FIG. 15 is an exemplary graphical user interface used by a user to log into their physician's web site to send and access messages in accordance with various embodiments of the invention. As shown in FIG. 15, the user may access his or her messages using the previously established userId and password. In this example, registration of the user with the physician via the physician's web site has been accepted by the physician, and the user receives a welcome message. The user may then send and receive messages such as online consultation messages.

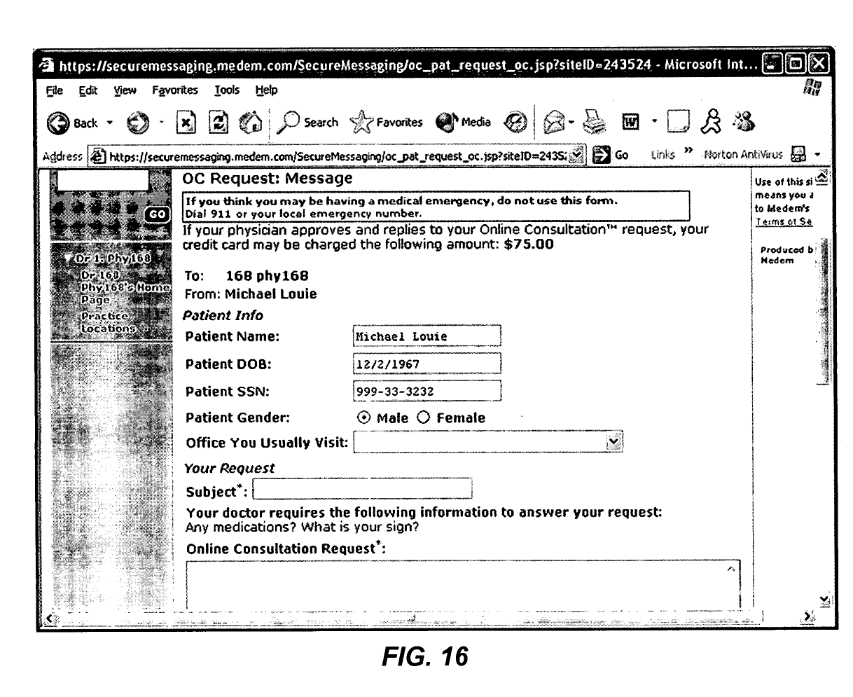

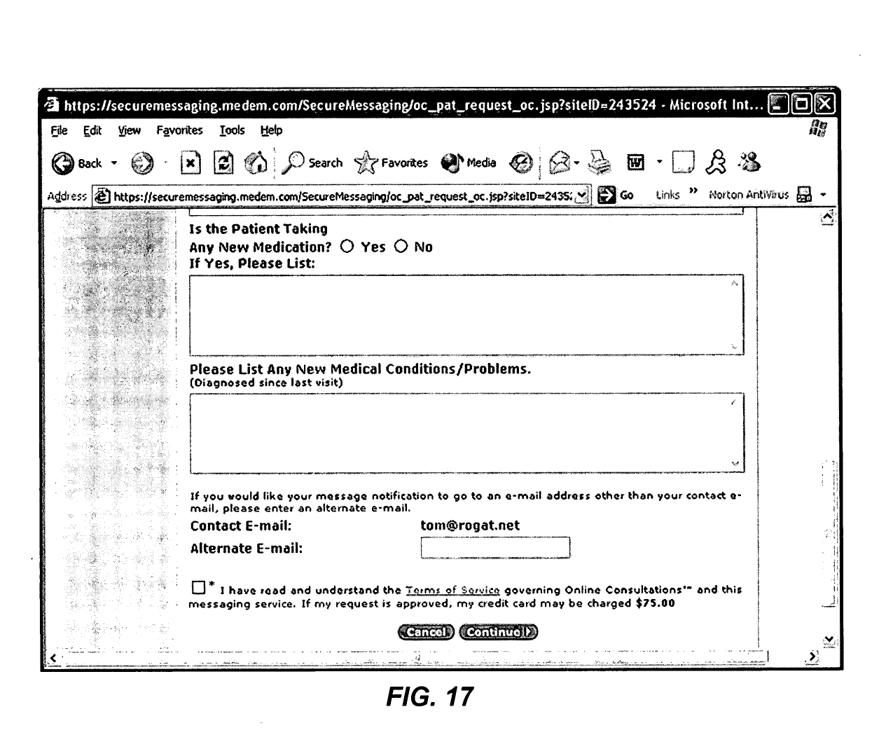

By clicking on the “Online Consultation Request” hypertext link of the physician's web site, the user may generate and transmit an online consultation request to a physician via the Internet. FIGS. 16-17 together illustrate an exemplary graphical user interface used by a user to generate an online consultation request in accordance with various embodiments of the invention. In this example, the online consultation request form includes fixed fields as well as requests mandatory information required by the physician in order to process the online consultation request. As shown in FIG. 16, the user may enter identifying information such as name, date of birth, social security number, and gender. In addition, when the user is a patient of the physician, the user can indicate the location of the office that the patient usually visits the physician. The user also answers one or more questions previously established by the physician. For instance, the physician may want to know if the user has any allergies. As another example, the physician may provide questions pertinent to his or her practice area. The user may then request medical information and/or medical advice within the space provided in the online consultation request form. In addition, as shown in FIG. 17, the user indicates whether he or she is taking any new medications, as well as lists those medications. The user also lists any medical conditions or problems such as those that have been diagnosed since the patient's last visit to the physician. At that time, the user may also enter an alternate e-mail address via which the physician can contact the patient. The user is also notified at this point of the maximum charge that his or her credit card may be charged. The user then checks the box, agrees to the Terms of Service and continues with the online consultation process.

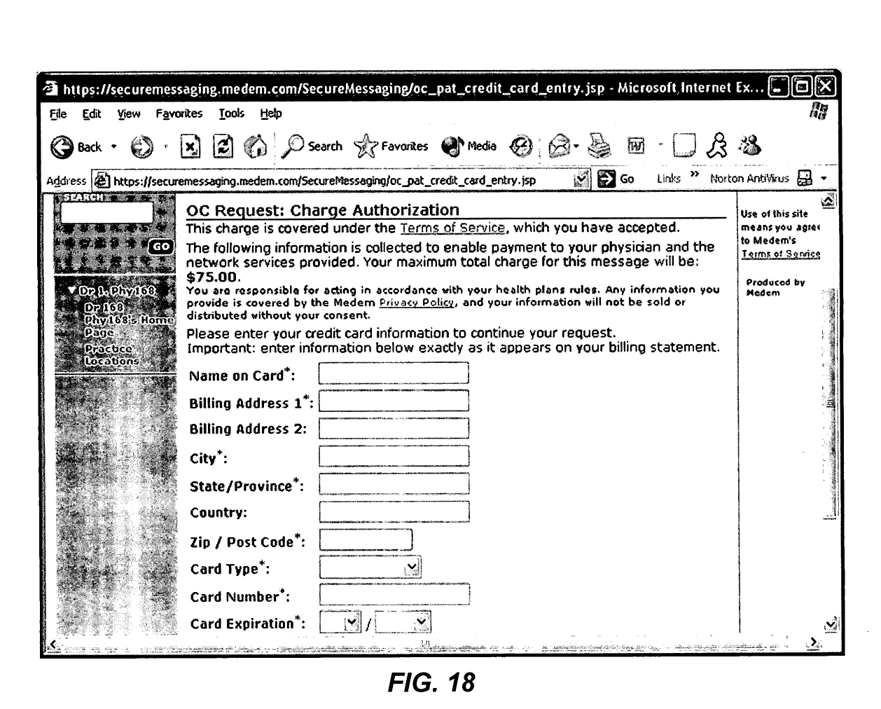

The user then submits a charge authorization for the online consultation. FIG. 18 is an exemplary graphical user interface presented to a user to authorize the charge for the online consultation request in accordance with various embodiments of the invention. As shown, the user enters credit card information, enabling a charge for the online consultation to be charged on the credit card. For instance, the user provides the name on the credit card, billing address, city, state, country, zip code, card type, card number, and expiration date. Of course, other types of payment may be authorized, including but not limited to, electronic check, electronic payment systems, and automatic withdrawal from a bank account (e.g., online or conventional bank account). As shown in FIG. 18, notification of the maximum charge for the online consultation is provided to the patient at this time.

From the information entered by the user, an online consultation request message is generated and sent from the user to the physician via the upon submission of the charge authorization. As described above, the online consultation request message may be sent to a specific physician as well as to a group of physicians. Specifically, in accordance with one embodiment, a notification message indicating that an online consultation request message is waiting to be read is sent via an email address. The email address may be associated with a group of healthcare providers, as well as with an individual healthcare provider (e.g., physician). When the physician receives the email notification, the physician then accesses the online consultation request message (e.g., via the third-party server). The physician may then choose to send an online consultation reply message including the requested medical information or advice to the user.

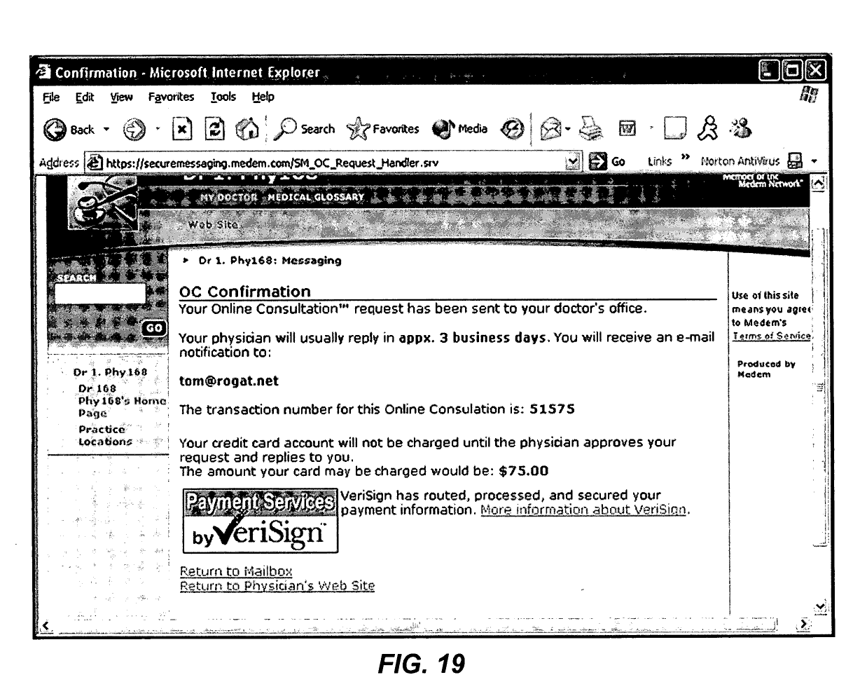

Once the user has submitted the online consultation request, the user is notified that the request has been sent to the physician's office. FIG. 19 is an exemplary graphical user interface presented to the user upon transmitting the online consultation request to the physician in accordance with various embodiments of the invention. As described above, during configuration of the physician's online consultation settings, the physician establishes a time period during which the user can expect to receive a response from the physician in response to the online consultation request message. Thus, the user is notified of this time and given a transaction number for the online consultation. In addition, the user is again notified of the maximum amount that may be charged to his or her credit card.

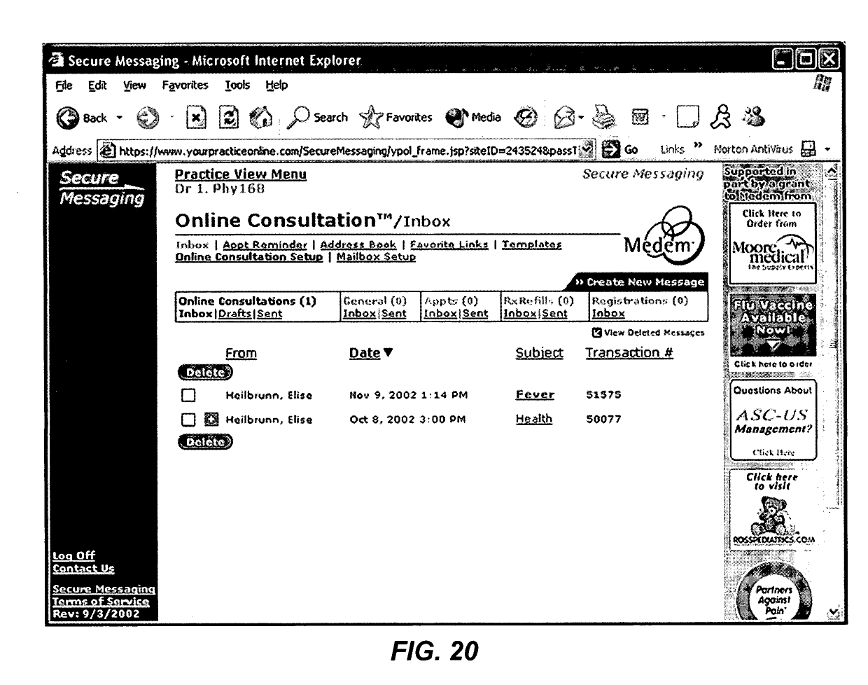

Upon submission of the online consultation request by the patient, the physician may access the online consultation requests via his or her online consultation in-box. FIG. 20 is an exemplary graphical user interface presented to the physician to enable the physician to access online consultation requests in his or her online consultation inbox in accordance with various embodiments of the invention. As shown in this example, the online consultation requests may be identified by sender, date, subject, and transaction number. The physician may choose to select and read a specific online consultation request by clicking on the subject of the request. Alternatively, the physician may decline to respond by deleting the online consultation request.

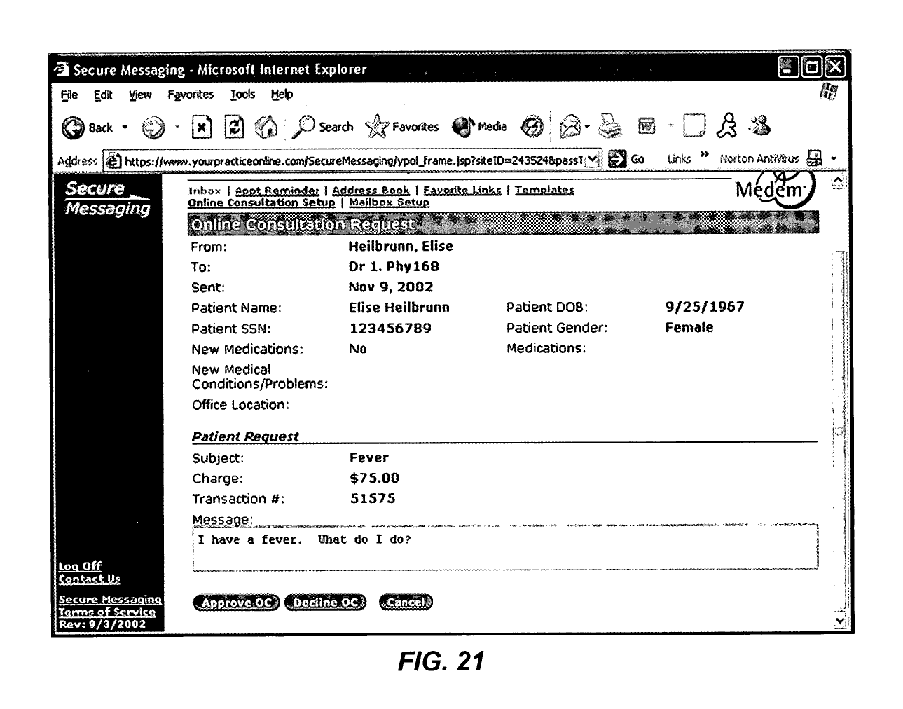

FIG. 21 is an exemplary graphical user interface illustrating an online consultation request message received by the physician in accordance with various embodiments of the invention. As shown, the online consultation request message may identify the sender, a specific physician to which the request was sent, patient name, social security number, date of birth, gender, medications the patient is taking, medical conditions or problems identified by the patient, and an office location typically visited by the patient. In addition, the online consultation request message indicates that the user-patient is requesting medical information and/or medical advice from a physician. For instance, the user may ask a medical question such as the best medication to remedy a fever.

Upon reading the online consultation request, the physician may either accept or decline the online consultation request. For instance, the physician may decline the online consultation request if he or she feels that there is not enough information to diagnose the condition or provide medical advice. Similarly, the physician may feel that the patient needs to be seen before a diagnosis or other medical information can be provided to the patient.

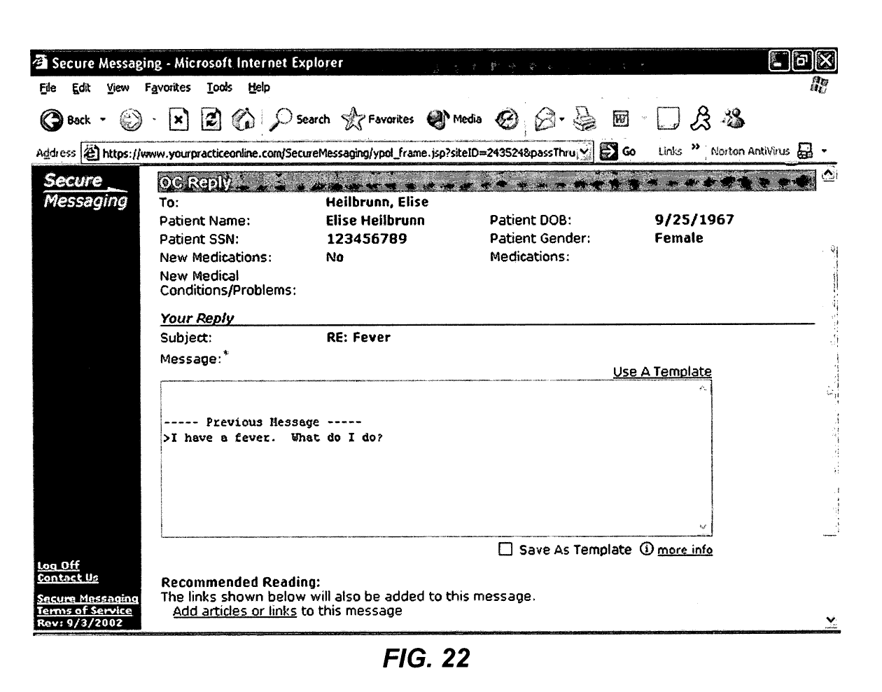

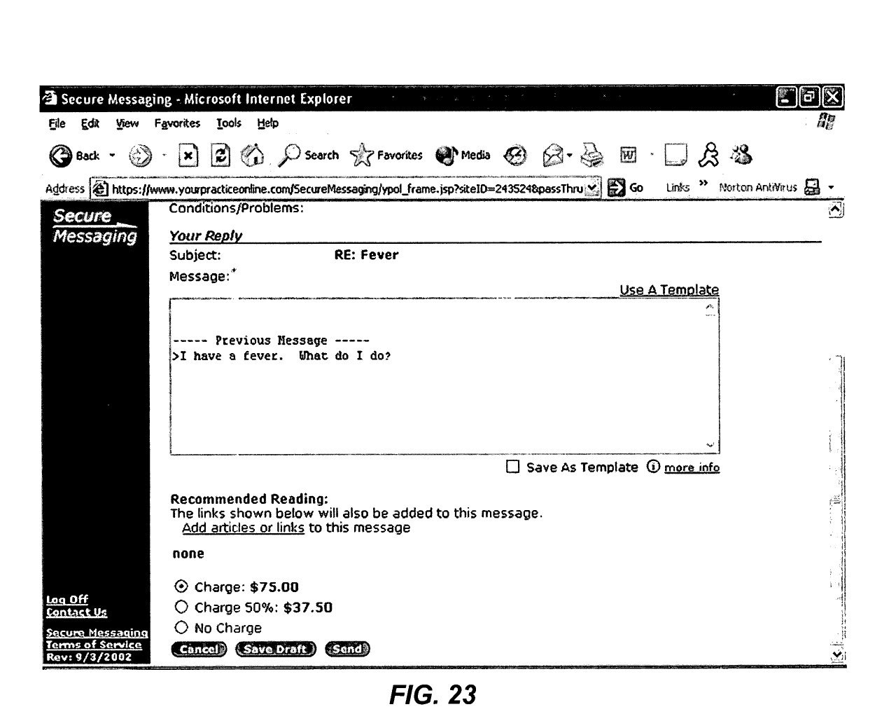

If the physician chooses to accept the online consultation request message, the physician responds by sending an online consultation reply message. FIGS. 22-23 together illustrate an exemplary graphical user interface for generating an online consultation reply message in accordance with various embodiments of the invention. In the online consultation reply message, the physician may provide medical information and/or medical advice. In order to provide this information or advice, the physician may choose to use a specific template including appropriate information for the particular problem or medical situation. In addition, the physician may provide one or more hypertext links to medical information on the Internet.

Each physician may personalize a set of libraries for his or her personal use. For instance, the physician may maintain a record of the web sites and hypertext links that they commonly access or repeatedly attach to online consultation reply messages. In addition, each physician may edit and create templates for use in generating online consultation reply messages.

As described above, the online consultation amount may be established on a per-patient or per-consultation basis. Thus, the physician may select or designate the appropriate online consultation amount at this time. Specifically, the physician may charge the patient less than or equal to the maximum online consultation amount previously established by the physician. In this example, the physician may choose to charge the maximum amount, a reduced amount such as a specified percentage (e.g., 50%), or may choose to provide an online consultation at no charge. As shown, the online consultation reply indicates the amount to be charged to the patient for the online consultation.

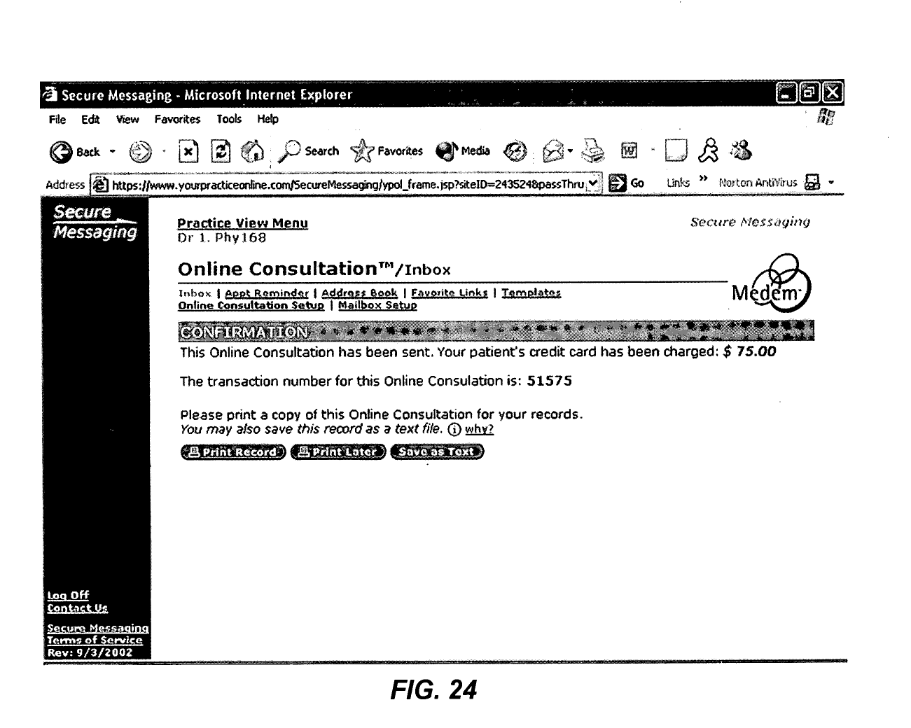

FIG. 24 is an exemplary graphical user interface presented to the physician upon transmitting the online consultation reply to the patient in accordance with various embodiments of the invention. As shown, the physician receives confirmation that the online consultation reply has been sent. In addition, the transaction number for the online consultation is provided to the physician. The physician may then choose to save the online consultation record or print the online consultation for his or her records.

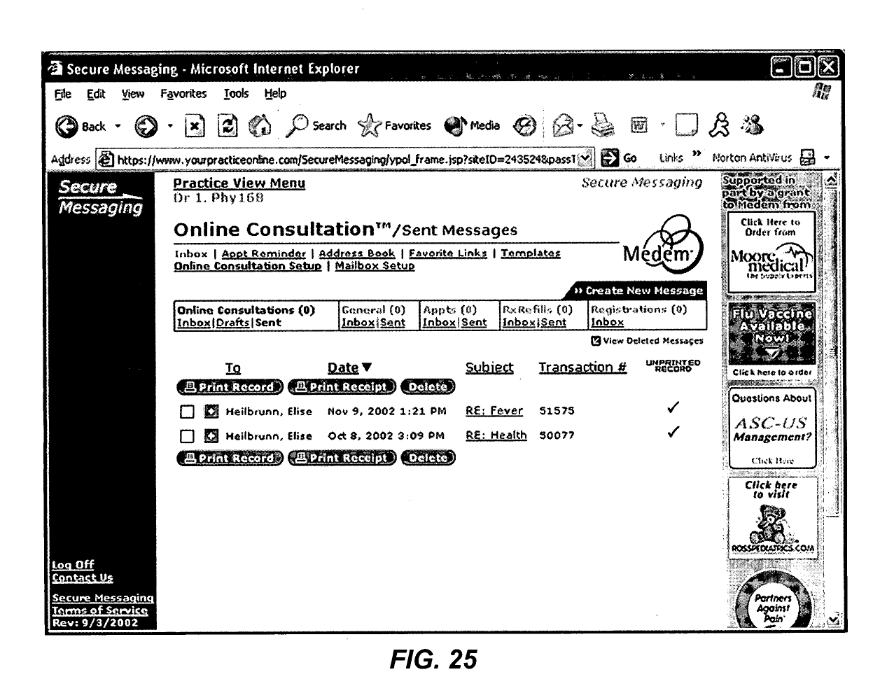

Once transmitted, the physician may access online consultation reply messages via the physician's mailbox. FIG. 25 is an exemplary graphical user interface enabling a physician to access his or her sent online consultation reply messages in accordance with various embodiments of the invention. From the physician's online consultation sent messages mailbox, the physician may access previously sent online consultation reply messages. For each reply message, the physician may choose to print the record, print a receipt or delete the record.

The user may also access his or her online consultation messages, including request and reply messages. Specifically, in accordance with one embodiment, the user is notified via his or her e-mail address when an online consultation reply message has been sent to the user. For instance, when the physician accepts or declines the online consultation request, the user may receive an accept or decline message via the e-mail address. Alternatively, the notification message received via the e-mail address may simply indicate that a message (e.g., an online consultation reply message) can be retrieved by the user at the physician's web site by entering the username and password established during the registration process. When the user logs into the physician's web site, the user may receive an accept message (or decline message), where the accept message indicates that an online consultation reply message will be or has been sent. The online consultation reply message may then be retrieved by the user via the physician's web site.

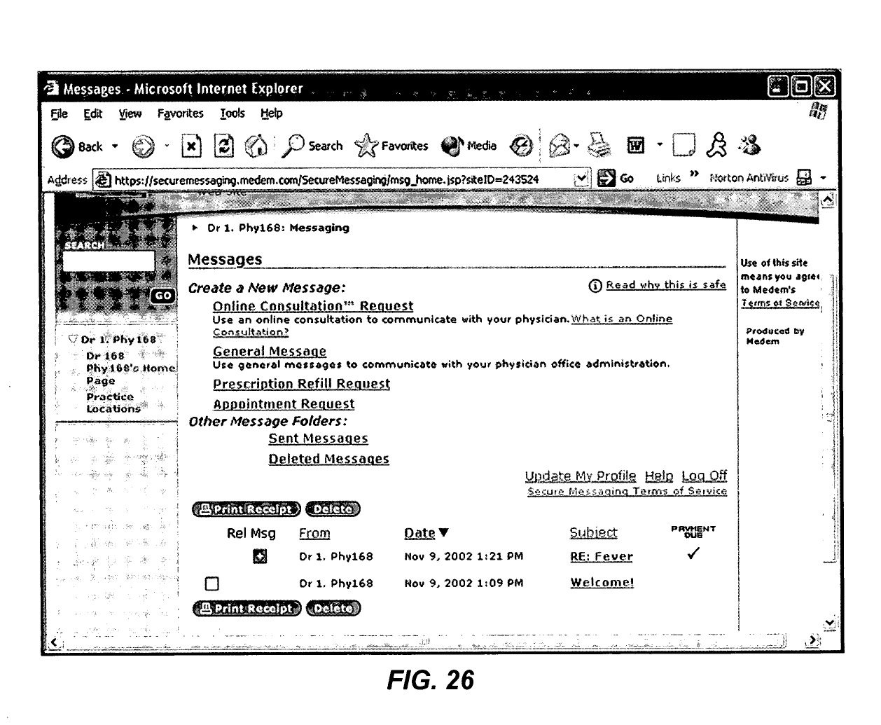

FIG. 26 is an exemplary graphical user interface presented to the user enabling the user to access online consultation reply messages in accordance with various embodiments of the invention. Each online consultation reply message may be identified by the sender, date, and subject. In addition, the online consultation reply message may indicate that payment is due. Once the user reads the online consultation reply message, the user may choose to print a receipt, print a record, or delete the message.

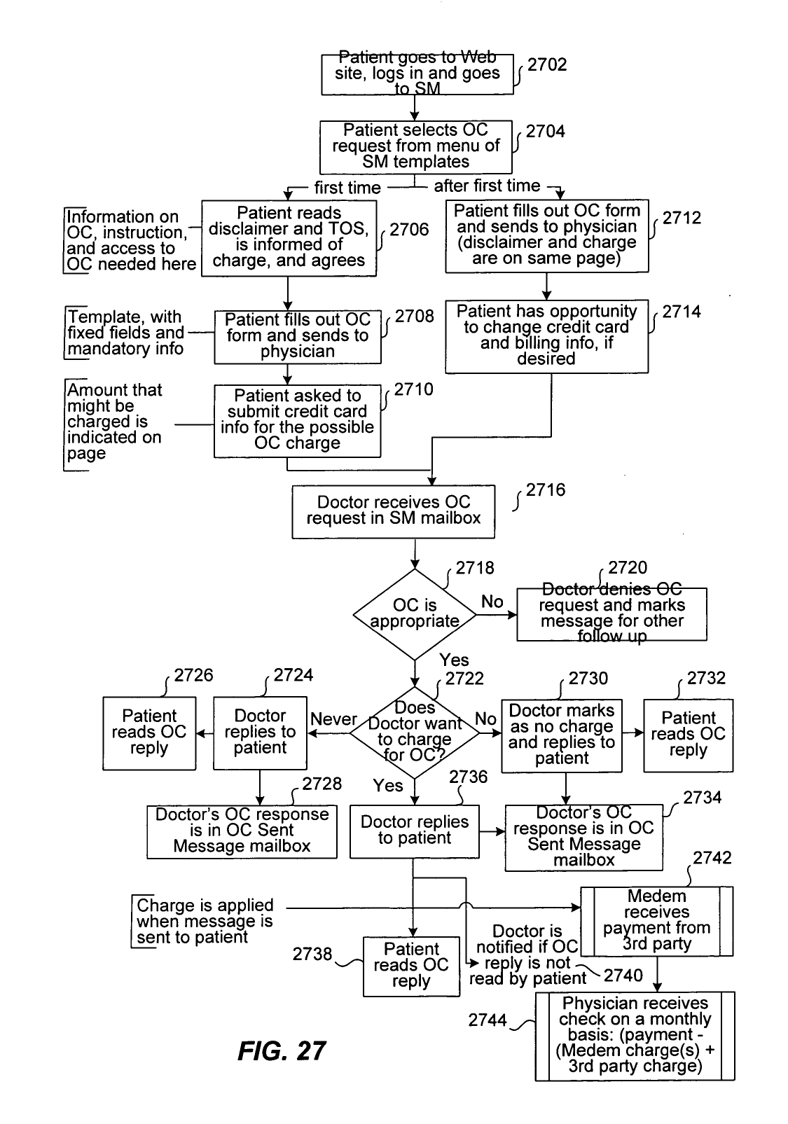

FIG. 27 is a process flow diagram presenting an overview of the online consultation process in accordance with various embodiments of the invention. As described above, a registered patient accesses the physician's web site, logs in, and proceeds to the Secure Messaging options at block 2702. The patient selects an Online Consultation request option from the menu of Secure Messaging templates at block 2704. For the first online consultation request submitted by the patient, the patient is presented with information and instruction on online consultation at block 2706. The patient then reads the disclaimer and Terms of Service, is informed of the potential charge, and agrees to the Terms of Service. The patient then fills out the online consultation request form and sends the online consultation request to the physician at block 2708. As described above, the online consultation request form includes fixed fields as well as mandatory information required by the physician in order to process the online consultation request. The patient is then asked to submit credit card information for the potential online consultation charge that may be incurred should the physician choose to reply to the online consultation request at block 2710. At this time, the patient is notified of the amount that may be charged to his or her credit card.

After the patient has submitted an initial online consultation request, the patient merely fills out an online consultation request form and sends it to the physician at block 2712 for subsequent online consultation requests. In other words, the disclaimer and charge may be provided on the online consultation form. The patient also has the opportunity to change credit card and billing information, if desired, at block 2714.

When the physician receives the online consultation request at block 2716, he or she determines whether sending an online consultation reply is appropriate at block 2718. The physician may then choose to deny the online consultation request at block 2720 and mark the message for other follow up with the patient. If the physician decides to proceed with sending an online consultation reply, the physician determines whether he wants to charge for the online consultation at block 2722. If the physician has selected never to charge for an online consultation (or to charge this particular patient for online consultations), the physician sends an online consultation reply to the patient at block 2724. The patient reads the online consultation reply at block 2726, and the online consultation reply is stored in the physician's online consultation sent message mailbox at block 2728 until the physician chooses to delete the message.

If the physician has decided at block 2722 to charge for online consultations, the physician decides whether he or she wants to charge for this particular online consultation. If the physician decides not to charge for this particular online consultation, the physician marks this online consultation reply as no charge at block 2730 and sends the online consultation reply to the patient. The patient then reads the online consultation reply at block 2732, which is saved in the physician's online consultation sent message mailbox at block 2734.

If the physician has decided to charge for this particular online consultation, the physician sends an online consultation reply at block 2736, which is saved in the physician's sent messages mailbox at block 2734. The patient may then read the online consultation reply at block 2738. The physician may also be notified if the online consultation reply is not read by the patient as shown at 2740.

When an online consultation reply message is sent to a patient, the third-party online consultation service receives payment for the online consultation at block 2742. For instance, the payment may be received from another third-party such as the patient's insurance company and/or the patient's credit card company. The physician then receives payment from the third party online consultation service at block 2744. For instance, the physician may receive payment in the form of a check from the third party online consultation service on a monthly basis. The check may be calculated by determining the payment received for the online consultation, and subtracting the third-party insurance or credit card company charge as well as the third-party online consultation service fee.

It may also be desirable to send routine messages to patients. For instance, the routine messages may be sent in association with a medication that has been prescribed or a medical condition with which the patient has been diagnosed. These messages, for example, may communicate medical advice or information such as side effects, refill reminders, etc. These messages may be stored as a group of messages to be sent sequentially, which will be referred to as a “compliance program.” For instance, each of the messages may be sent when a specific condition has been satisfied, such as a lapse of time or in response to input from the user obtained in relation to a previously transmitted message. Input from the user in response to a message may determine the next message that will be transmitted to the user. Thus, the messages may be stored in a decision tree format as well as a list format, depending upon whether input is to be obtained from the user. Thus, automated compliance program messaging may be triggered by specific patient responses. User responses may be transmitted in the format of forms that both solicit patient input as well as provide structured information back to the physician.

It is also important to note that the messages may be sent to the patient as well as a user (e.g., caregiver) other than the patient, such as where the patient is a minor or incapable of communicating or caring for themselves (e.g., due to age, a handicap or senility). Thus, the user may be a relative (e.g., parent or sibling) or caretaker of a patient of the healthcare provider to which the compliance program is directed.

A plurality of compliance programs may be stored for access by a healthcare provider. Each compliance program may be generated locally or via the Internet. Each library of compliance programs may include compliance programs that are public as well as those that are private (e.g., a physician's personally edited compliance programs). Some of these compliance programs may be “send only” (e.g., read only) programs, which cannot be modified. Other compliance programs may be modifiable and therefore customizable by the healthcare provider. Specifically, each message in a compliance program may serve as a template which is customizable by the healthcare provider. These templates may be based, for instance, on a specialty of practice. Alternatively, a template may be “blank,” enabling a healthcare provider to establish a compliance program “from scratch.” In addition, the healthcare provider may choose to add a compliance program, delete a compliance program, or edit a specific compliance program. Editing a specific compliance program may, for example, include adding a message to the compliance program, deleting a message from the compliance program, rearranging messages within the compliance program, and/or editing the text of a message within the compliance program. The healthcare provider may also wish to append a note from the healthcare provider to one or more of the messages, such as where the compliance program or message is “send only.”. Alternatively, the healthcare provider may enter a URL, article, or text into one or more of the messages in the compliance program. In addition, the healthcare provider or generator of the message may choose to require the user to input a response to the message, which may be used to determine the next message in the compliance program to be transmitted to the user.

Each compliance program may be established to serve a particular purpose or particular population of patients. Thus, each program can be unique in terms of the content of the messages contained within (e.g., template), the number of messages, and the ability to set timing or delivery intervals (e.g., conditions) for the transmission of the messages. For instance, a compliance program may be associated with a new medication that has been prescribed or a new medical condition that has been diagnosed. As another example, a compliance program may be associated with a chronic (e.g., ongoing) medication or medical condition. Messages may be different for a new prescription compliance program and a prescription renewal compliance program. Any message in the compliance program may be a prescription renewal reminder in such a “chronic” compliance program. This renewal reminder may also enable the user to click a link within a compliance message to renew the prescription (if this link has been added to that message). Thus, the healthcare provider may have the ability to add or remove such a URL link from any compliance message.

In order to edit a compliance program by establishing the messages in the compliance program, it may also be desirable to define or alter the condition(s) associated with one or more of the messages in the compliance program. Specifically, the healthcare provider may define a condition such that a condition is associated with one or more of the messages that must be satisfied in order to trigger transmission of the corresponding message to the user. A condition may include various user and/or physician initiated events, as well as time factors.

The healthcare provider may choose to associate a specific compliance program with one or more users/patients, such as a set of one or more individuals who have been diagnosed with a particular medical condition or who have been prescribed a particular medication. The healthcare provider may then view information associated with a specific compliance program, as well as the status of a particular executing compliance program for a particular user or set of users. The healthcare provider may also view a compliance program that is executing for all patients enrolled in that compliance program. The healthcare provider may, therefore, monitor the stage of execution of a compliance program.

A compliance program may be initiated by a healthcare provider or by a user (e.g., patient) when enabled by the healthcare provider. For instance, an online consultation may end in the healthcare provider option to initiate the compliance program for the medical condition diagnosed. As another example, a prescription renewal application may end in the healthcare provider option to initiate the compliance program for the medication prescribed.

A compliance program, once initiated, is executed until completion unless disabled or cancelled by the user or healthcare provider. Each compliance program may include a set of messages which are executed by a set of computer-readable instructions. The set of computer-readable instructions may be associated with a compliance program, or serve as a stub that executes any compliance program in accordance with conditions/rules that have been established with the messages in the compliance program.

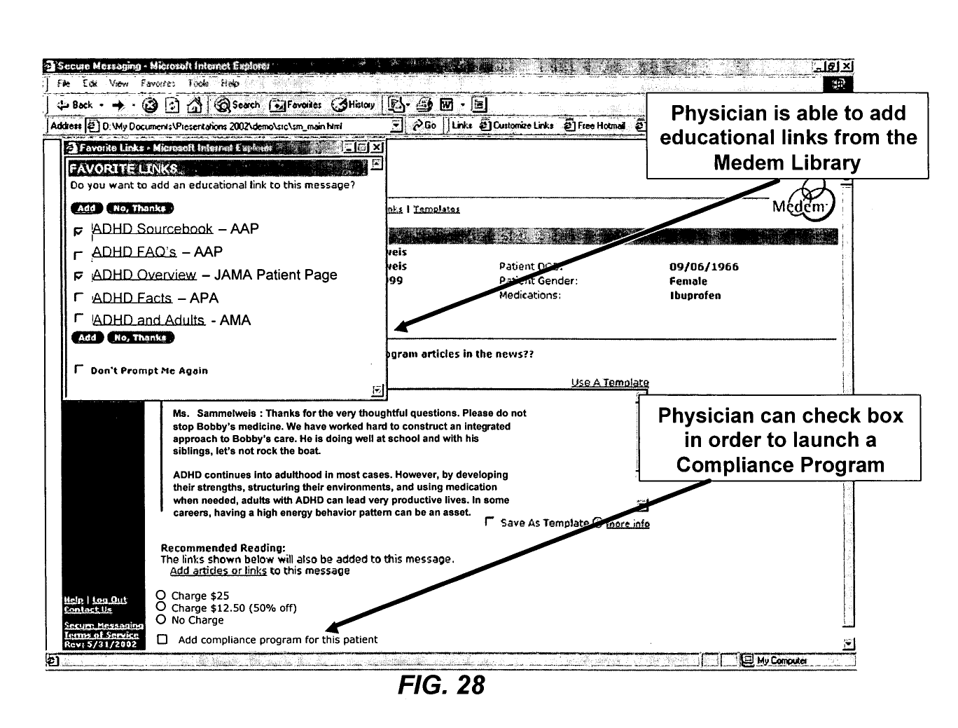

FIG. 28 is an exemplary graphical user interface presented to the user upon initiation of a compliance program by a healthcare provider in accordance with various embodiments of the invention. As described above, the healthcare provider may also choose to launch a compliance program from a library of compliance programs available to the healthcare provider. As shown, when a healthcare provider sends a message to the user, he may add URL links to the message. For instance, the URL links may be stored in a library available to the physician or healthcare provider. In addition, the healthcare provider may choose to launch a compliance program, such as through the checking of a box in association with a reply message (e.g., to an online consultation message).

As shown in FIG. 28, the healthcare provider has initiated the “Concerta Therapeutic messages” compliance program. Thus, the selected compliance program may relate to a medical condition such as Attention Deficit Hyperactivity Disorder (ADHD). This message is sent to the parent/user who is responsible for the minor child. This initial message that is transmitted upon initiation of the compliance program provides general medical information relating to ADHD. In this example, the first paragraph has been edited to be specific to the patient. For instance, the text relates to the child's school and siblings. However, the second paragraph is a standard paragraph that is part of the initial message in this particular compliance program.

Subsequent messages in a particular compliance program may be transmitted upon satisfaction of a condition associated with the corresponding message. For instance, the condition may be a lapse of a specified period of time (e.g., one or more days or weeks), an action by the user (e.g., filling a prescription of the medication prescribed)), and/or a specific response provided by the user in response to the previous compliance message transmitted to the user. Thus, the next message in the compliance program to be transmitted may be conditional upon the response received from the user. Moreover, the compliance message and associated response may be provided in a single form transmitted to the user. Alternatively, the user response may be transmitted separately from the compliance message.

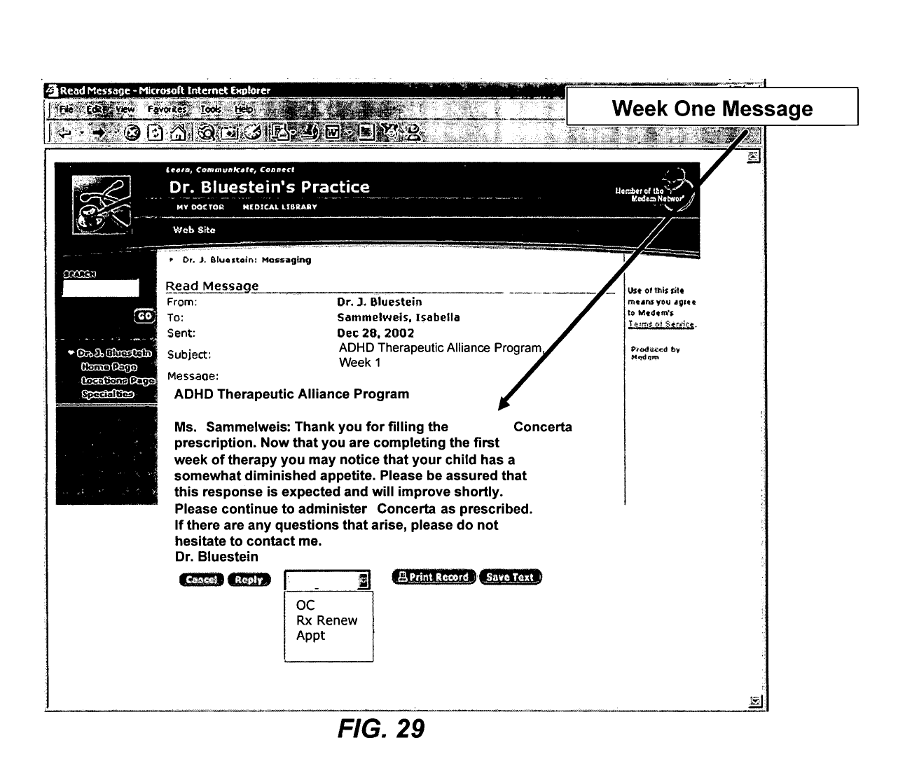

FIG. 29 is an exemplary graphical user interface presented to a user at the end of the first week of a drug therapy in accordance with various embodiments of the invention. As shown, the subject of the compliance message may identify the compliance program in which the user has been entered. In this example, the compliance message has been edited by the healthcare provider to include the user's name as well as the physician's name. In addition, the message has been customized to refer to the user's child, or, alternatively, a compliance program specific to parents has been initiated. This compliance message may be sent automatically one week after the compliance program has been initiated. Alternatively, the compliance message may be sent one week after the prescription has been filled. If the physician wishes to customize the messages, the messages may be edited prior to being transmitted. This editing may occur when the compliance program is initiated or on a per-message basis at the time the message is to be transmitted. For example, each message may be placed in the healthcare provider's inbox for editing and transmission by the healthcare provider when the condition associated with the message has been satisfied. In this instance, the messages may not be transmitted automatically to the user. Thus, the condition that has been satisfied may include a lapse of a period of time as well as the particular action of the user. The lapse of the period of time may be with respect to initiation of the compliance program, an action of the user, or transmission of a message in the compliance program such as the previous message in the compliance program.

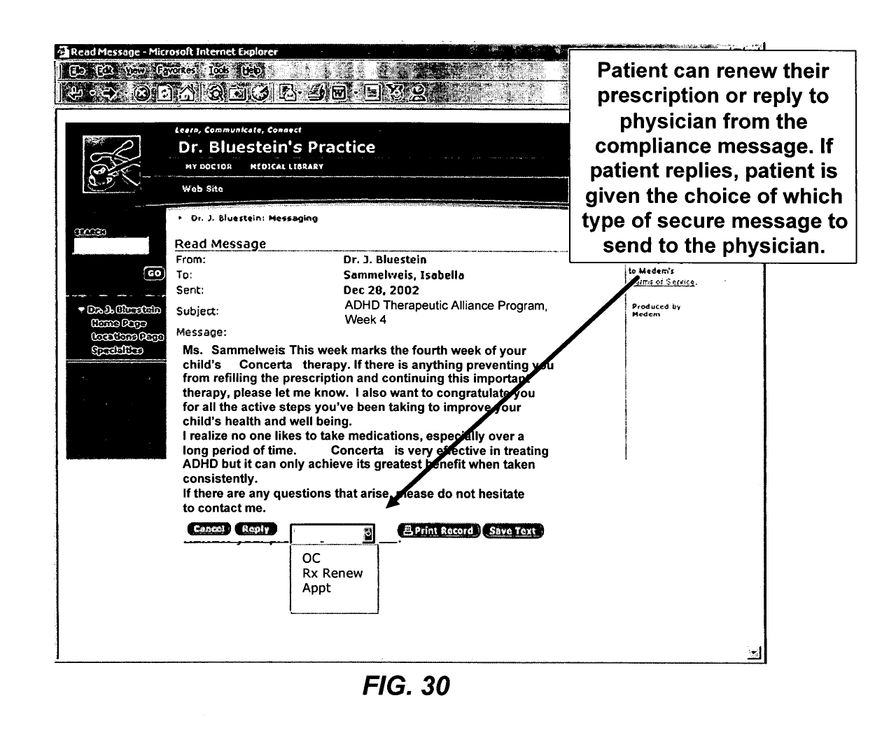

FIG. 30 is an exemplary graphical user interface presented to a user at the end of the fourth week of a drug therapy in accordance with various embodiments of the invention. In this example, the compliance message has been transmitted after four weeks have lapsed since the compliance program has been initiated, since the prescription has been filled by the user, or three weeks since the transmission of the previous compliance message described above with reference to FIG. 29.

From a compliance message, the user (e.g., patient) can renew a prescription or reply to the healthcare provider (e.g., physician). If the user replies, the user is given the choice of which type of secure message to send to the physician. For instance, the user may wish to send an online consultation request message, a prescription renewal request message, or an appointment request message.

The compliance program (e.g., template) may enable a healthcare provider to create an adverse reaction functionality. Specifically, if a patient has an adverse reaction to a medication that has been prescribed to them, the patient may send this information to the healthcare provider. For instance, a message or prompt may be provided to the user requesting adverse reaction information. This information may then be sent to the healthcare provider in a secure message such as that described above.

In the example described above, the healthcare provider (e.g., physician) initiated the compliance program. In addition, one or more of the compliance programs available to the healthcare provider may be configured such that they may be initiated by the user. In other words, the user may view and select one or more of the compliance programs for execution in association with the user. For instance, one or more of the compliance programs available to the healthcare provider may be marked (e.g., by the healthcare provider) to enable the user to self-enable the compliance program or, alternatively, prevent the user from self-enabling the compliance program. In the event that the user wishes to initiate such a compliance program, a notification may be transmitted to the healthcare provider informing the healthcare provider that the user has initiated the compliance program.

As described above, a compliance program may be initiated by the user or healthcare provider. Alternatively, execution of a compliance program may be automatically initiated when a particular event occurs. For instance, a particular compliance program may be automatically launched, or selected and initiated by the healthcare provider, when the healthcare provider generates or transmits a new message to the user, when an online consultation request is received, when an online consultation reply is generated or transmitted to the user, when a prescription renewal request is received, when an appointment request is received, when a prescription renewal reply is transmitted, when a general message is received from the user when a general message reply is transmitted to the user, or when a message is transmitted from a third party system such as a payor when a medication was not picked up or refilled after prescribed. In other words, the condition associated with one or more of the messages in a compliance program may be satisfied when information is received from a third party indicating that a prescription for the medication has not been filled or renewed as prescribed. The user may then be surveyed for the reason for non-compliance with respect to the non-fill or non-renewal action.

In addition to initiating execution of a particular compliance program, it may be desirable to disable (e.g., cancel) execution of a particular compliance program and/or in association with one or more users (even if already executing). This may be performed by the healthcare provider for a user or group of users, as well as all users. Similarly, the user may wish to disable execution of a particular compliance program that has been initiated for that user. This may be desirable, for example, if the user wishes to no longer receive the email notices that he or she has been receiving. When the user disables a particular compliance program, a notification may be transmitted to the healthcare provider informing the healthcare provider that the user has disabled the compliance program for the user. The healthcare provider may wish to reinitiate the compliance program, initiate a different compliance program, or contact the user in another more conventional manner. Moreover, it may be desirable to disable non-functioning compliance programs or those that are undergoing modifications (e.g., such as where new side-effects have been discovered in association with a particular medication).

In addition to the features described above with respect to compliance programs, the features available with respect to other online consultation messages are also available for use with compliance program messages. Thus, the compliance messages are accessed in a secure manner by the user. In addition, the healthcare provider (e.g., physician) may assign permissions to other office staff to initiate or edit compliance programs as part of messaging permissions. In other words, one or more individuals associated with the healthcare provider (e.g., nurse, other physicians) may be given privileges such as read/write privileges. Moreover, the healthcare provider may store, view, and print messages from his or her in-box. Finally, for patients who are not online, there is the ability for a provider to generate and/or execute specific compliance programs that include a telephony-based component. In other words, a compliance program may include a telephony-based component and/or a component enabling secured messaging, e-mail or Internet communications. These programs and messages may be different from the web based version of the programs. Alternatively, the messages may be the same or substantially equivalent to those provided in the web based version of the programs. Patients will be able to receive compliance messages by phone (where the compliance messages are converted from text to voice), as well as communicate with the compliance program via phone. The telephony-based component may be automatically activated (or de-activated) by the provider for specific users and/or activated (or de-activated) by the user. Similarly, the “web-based” component may be automatically activated (or de-activated) by the provider for specific users and/or activated (or de-activated) by the user. In this manner, a compliance program may be set up to deliver messages via telephone (or other medium) to specific users (or all users). Patients will also be able to self-enroll or disenroll via phone, and providers will be able to enroll patients via the web.

In accordance with the above-described embodiments, it is assumed that electronic mail is an insecure medium and may be easily intercepted. Communication is therefore implemented in a two-tier communication process via e-mail notification and a secure, authenticated environment on the physician web site. However, it is important to note that physician-patient communications may also be transmitted via e-mail, such as using an encrypted e-mail system, or other secure communication system. In this manner, the present invention enables online physician-patient communications to comply with federally mandated privacy requirements such as HIPAA.

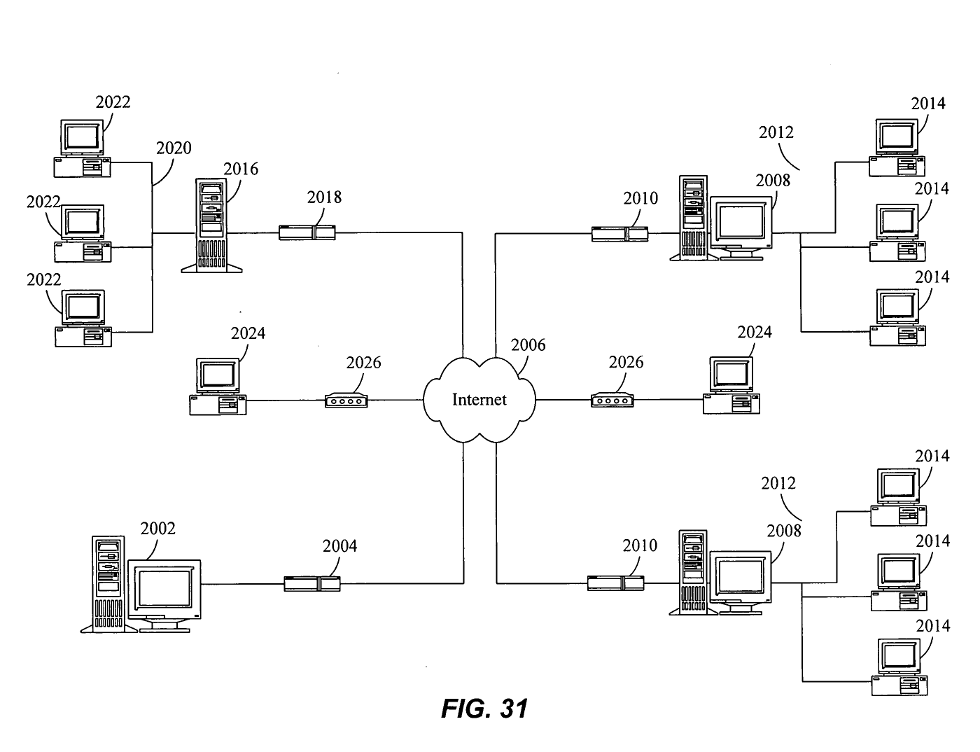

FIG. 31 is a block diagram of a hardware environment in which the various embodiments of the present invention may be implemented. The web site at which communications between users and one or more physicians are facilitated according to the invention is located on a server 2002, which is connected by a router 2004 to the Internet 2006. Each individual physician's web site is hosted by the server 2002. In addition, physician office servers 2008 may also be connected to the Internet via routers 2010 in order to receive the transmission of e-mails and online consultation messages from the server 2002. The physician office servers 2008 may run software as well as store secure messages such as online consultation request and/or reply messages. For instance, it may be desirable to download online consultation request and/or partially completed reply messages, prepare online consultation reply messages, and upload those online consultation reply messages upon completion. Physician office servers 2008 may have networks 2012 associated therewith interconnecting a plurality of personal computers or work stations 2014. In this manner, an office network may access the server 2002. User-patients (represented by computers 2022 and 2024) may be connected to the Internet in a variety of ways. For example, a patient may be connected from his home via a modem 2026, or from his workplace via a network 2020, a file server 2016, and a router 2018. It will be understood that, according to various embodiments of the invention, patients may gain access to the web site on server 2002 via a variety of hardware configurations. Similarly, businesses may be coupled to the web site on server 2002 in order to receive the transmission of communications such as e-mails from the web site. For example, a business may consist of an individual on his home computer 2024 or other device, such as a pager, phone or other hand-held device. Similarly, a consumer may be an employee who accesses the web site from his computer 2014 at his place of employment which is a business. It will also be understood that the hardware environment of FIG. 31 is shown for illustrative purposes and that a wide variety of hardware environments may be employed to implement the various embodiments of the present invention. It should also be understood that specific embodiments of the methods and processes described herein are implemented as computer program instructions, i.e., software, in the memory of server 2002.

Various embodiments of the invention can also be embodied as computer readable code on a computer readable medium. The computer readable medium is any data storage device that can store data, which can thereafter be read by a computer system. Examples of the computer readable medium include read-only memory, random-access memory, CD-ROMs, magnetic tape, and optical data storage devices.

Although illustrative embodiments and applications of this invention are shown and described herein, many variations and modifications are possible which remain within the concept, scope, and spirit of the invention, and these variations would become clear to those of ordinary skill in the art after perusal of this application. For instance, the present invention is based upon the generation and transmission of online consultation messages using a two-tier system, preferably in the form of electronic mail and via a physician's web site. However, it should be understood that the present invention is not limited to this arrangement, but instead would equally apply regardless of the mode of transmission or system configuration. Accordingly, the present embodiments are to be considered as illustrative and not restrictive, and the invention is not to be limited to the details given herein, but may be modified within the scope and equivalents of the appended claims.

What is claimed is:

1. A method of providing medical advice or medical information from a healthcare provider to a user via the Internet, comprising:
associating a compliance program with the user; and
executing the compliance program, the compliance program including one or more messages to be transmitted to the user when a condition associated with the corresponding message is satisfied, each of the messages including medical advice or medical information corresponding to a medication or medical condition.

2. The method as recited in claim 1, wherein one or more of the messages includes a URL enabling a patient to renew a prescription for the medication.

3. The method as recited in claim 1, further comprising:
marking the compliance program to enable the user to self-enable the compliance program.

4. The method as recited in claim 1, further comprising:
marking the compliance program to disable the user from self-enabling the compliance program.

5. The method as recited in claim 1, further comprising:
assigning permission to one or more individuals associated with the healthcare provider to initiate the compliance program.

6. The method as recited in claim 1, further comprising:
assigning permission to one or more individuals associated with the healthcare provider to edit the compliance program.

7. The method as recited in claim 1, wherein the medication or medical condition is new.

8. The method as recited in claim 1, wherein the medication or medical condition is chronic.

9. The method as recited in claim 1, wherein an online consultation ends in the healthcare provider option to initiate the compliance program for the medical condition diagnosed.

10. The method as recited in claim 1, wherein a prescription renewal application ends in the healthcare provider option to initiate the compliance program for the medication prescribed.

11. The method as recited in claim 1, wherein the last message in the compliance program is a prescription renewal reminder.

12. The method as recited in claim 1, wherein each of the messages in the compliance program are to be sent sequentially to the user.

13. The method as recited in claim 1, wherein a set of the messages in the compliance program are to be sent sequentially to the user.

14. The method as recited in claim 12, wherein one of the messages is to be automatically transmitted to the user when a condition associated with the corresponding message is satisfied.

15. The method as recited in claim 12, wherein one of the messages is to be automatically transmitted to the user when information from a third party is received.

16. The method as recited in claim 15, wherein the information from the third party is received when the medication was not picked up or refilled after prescribed.

17. The method as recited in claim 1, wherein one of the messages includes at least one of information associated with side effects of a medication that has been prescribed and a refill reminder associated with the medication that has been prescribed.

18. The method as recited in claim 1, wherein the messages of the compliance program are stored in a tree format.

19. The method as recited in claim 1, further comprising:
when a condition associated with one of the messages is satisfied, transmitting the corresponding message to the user.

20. The method as recited in claim 19, further comprising:
receiving a response from the user after the message is transmitted to the user.

21. The method as recited in claim 20, wherein the response indicates an adverse reaction to the medication.

22. The method as recited in claim 21, wherein the message requests information regarding any adverse reaction to the medication.

23. The method as recited in claim 20, wherein the next message in the compliance program to be transmitted is conditional upon the response received from the user.

24. The method as recited in claim 23, wherein the message and associated response are provided in a form transmitted to the user.

25. The method as recited in claim 20, wherein the response is an online consultation request message, a prescription renewal request message, or an appointment request message.

26. The method as recited in claim 1, further comprising:
initiating execution of the compliance program, wherein the compliance program is initiated by the user or the healthcare provider.

27. The method as recited in claim 26, further comprising:
transmitting a notification to the healthcare provider informing the healthcare provider that the user has initiated the compliance program when the compliance program is initiated by the user.

28. The method as recited in claim 1, further comprising:
disabling the compliance program for the user.

29. The method as recited in claim 28, wherein disabling is performed by the healthcare provider.

30. The method as recited in claim 28, wherein disabling is performed by the user.

31. The method as recited in claim 30, further comprising:
sending a notification to the healthcare provider informing the healthcare provider that the user has disabled the compliance program for the user when the user disables the compliance program for the user.

32. The method as recited in claim 1, further comprising:
deleting the compliance program.

33. The method as recited in claim 1, further comprising:
modifying the compliance program.

34. The method as recited in claim 1, wherein execution of the compliance program is initiated at least one of when the healthcare provider generates or transmits a new message to the user, when an online consultation requst is received, when an online consultation reply is generated or transmitted to the user, when a prescription renewal request is received, when an appointment request is received, when a prescription renewal reply is transmitted, when a general message is received from the user, or when a general message reply is transmitted to the user.

35. The method as recited in claim 1, wherein the user is a patient of the healthcare provider.

36. The method as recited in claim 1, wherein the user is a relative or caretaker of a patient of the healthcare provider to which the compliance program is directed.

37. The method as recited in claim 1, wherein the condition includes a lapse of a specified period of time.

38. The method as recited in claim 37, wherein lapse of the period of time is with respect to initiation of the compliance program, an action of the user, or transmission of a message in the compliance program.

39. The method as recited in claim 1, wherein the condition includes an action of the user.

40. The method as recited in claim 39, wherein the action is a filling of a prescription of the medication.

41. The method as recited in claim 1, wherein the compliance program is selectable from a plurality of compliance programs.

42. The method as recited in claim 41, whereon one or more of the compliance programs are send only programs, wherein each of the messages of the send only programs can be sent by the healthcare provider but cannot be edited by the healthcare provider.

43. The method as recited in claim 41, further comprising:
selecting the compliance program from the plurality of compliance programs.

44. The method as recited in claim 1, wherein the compliance program cannot be modified by the healthcare provider.

45. The method as recited in claim 1, further comprising:
modifying one or more of the messages in the compliance program.

46. The method as recited in claim 45, further comprising appending a note from the healthcare provider to one or more of the messages.

47. The method as recited in claim 45, further comprising:
entering a URL, article, or text into one or more of the messages in the compliance program.

48. The method as recited in claim 45, further comprising:
editing the text of one or more of the messages in the compliance program.

49. The method as recited in claim 1, further comprising:
adding one or more messages to the compliance program or deleting one or more messages from the compliance program.

50. The method as recited in claim 1, further comprising:
specifying an interval for delivery for each of the messages.

51. The method as recited in claim 50, wherein the interval is defined with respect to a previous one of the messages to be transmitted to the user or with respect to the first message of the compliance program.

52. The method as recited in claim 1, further comprising:
defining a condition such that a condition is associated with one or more of the messages that must be satisfied in order to trigger transmission of the corresponding message to the user.

53. A method of providing medical advice or medical information from a healthcare provider to a user via the Internet, comprising:
selecting a compliance program from a plurality of compliance programs;
associating the compliance program with one or more users; and
executing the compliance program, the compliance program including one or more messages to be transmitted when a condition associated with the corresponding message is satisfied, each of the messages including medical advice or medical information corresponding to a medication or medical condition.

54. The method as recited in claim 53, wherein each of the plurality of compliance programs has an associated message content of the messages in the compliance program.

55. The method as recited in claim 53, wherein one or more of the plurality of programs may be configured with one or more conditions associated with the messages in the corresponding compliance program.

56. The method as recited in claim 53, further comprising:
viewing a status or information associated with one of the compliance programs.

57. The method as recited in claim 56, wherein the status or information is viewed for one or more of the users associated with the one of the compliance programs.

58. The method as recited in claim 56, wherein the status or information is viewed for all users associated with the corresponding one of the compliance programs.

59. The method as recited in claim 53, wherein the condition is separately satisfied with respect to each of the users such that the corresponding message is transmitted to the corresponding user when the condition is satisfied with respect to the user.

60. The method as recited in claim 53, wherein the condition associated with one of the messages is satisfied when information is received from a third party indicating that a prescription for the medication has not been filled or renewed.

61. The method as recited in claim 60, further comprising:
surveying the user for the reason for non-compliance with respect to the non-fill or non-renewal action.

62. The method as recited in claim 53, further comprising:
repeating the selecting, associating, and executing steps with respect to a second one of the plurality of compliance programs.

63. The method as recited in claim 59, wherein the one or more users have the medical condition.

64. The method as recited in claim 59, wherein the one or more users have been prescribed the medication by the medical provider.

65. The method as recited in claim 59, further comprising:
disabling one or more of the compliance programs for one or more of the users.

66. The method as recited in claim 59, further comprising:
deleting one or more of the compliance programs.

67. The method as recited in claim 59, further comprising:
adding a compliance program to the compliance programs.

68. The method as recited in claim 59, further comprising:
editing one of the compliance programs.

69. The method as recited in claim 59, wherein one or more of the compliance programs may be selected and executed by the user.

70. The method as recited in claim 53, wherein one or more of the compliance programs include messages that are directed to caregivers.

71. A method of providing medical advice or medical information from a healthcare provider to a user via the telephone, comprising:
creating a compliance program;
associating the compliance program with the user; and
executing the compliance program, the compliance program including one or more messages to be transmitted to the user via the telephone when a condition associated with the corresponding message is satisfied, each of the messages including medical advice or medical information corresponding to a medication or medical condition.

72. The method as recited in claim 71, wherein the compliance program is created using the Internet.

73. The method as recited in claim 71, further comprising:
enrolling the user in the compliance program via the telephone.

74. The method as recited in claim 71, further comprising:
disenrolling the user in the compliance program via the telephone.

75. The method as recited in claim 71, further comprising:
setting up the user to receive messages via the telephone, thereby enabling the user to receive one or more messages via the telephone.

76. The method as recited in claim 71, wherein the compliance program includes one or more additional messages to be transmitted to the user via the Internet when a condition associated with the corresponding message is satisfied.

77. The method as recited in claim 76, further comprising:
setting up the user to receive messages via the Internet.

78. The method as recited in claim 76, further comprising:
disabling the messages to be transmitted to the user via the Internet.

79. A computer-readable medium storing thereon computer-readable instructions for providing medical advice or medical information from a healthcare provider to a user via the Internet, comprising:
instructions for associating a compliance program with the user; and
instructions for executing the compliance program, the compliance program including one or more messages to be transmitted to the user when a condition associated with the corresponding message is satisfied, each of the messages including medical advice or medical information corresponding to a medication or medical condition.

80. An apparatus for providing medical advice or medical information from a healthcare provider to a user via the Internet, comprising:
means for associating a compliance program with the user; and
means for executing the compliance program, the compliance program including one or more messages to be transmitted to the user when a condition associated with the corresponding message is satisfied, each of the messages including medical advice or medical information corresponding to a medication or medical condition.

81. A computer-readable medium storing thereon computer-readable instructions for providing medical advice or medical information from a healthcare provider to a user via the Internet, comprising:
instructions for selecting a compliance program from a plurality of compliance programs;
instructions for associating the compliance program with one or more users; and
instructions for executing the compliance program, the compliance program including one or more messages to be transmitted when a condition associated with the corresponding message is satisfied, each of the messages including medical advice or medical information corresponding to a medication or medical condition.

82. A computer-readable medium storing thereon computer-readable instructions for providing medical advice or medical information from a healthcare provider to a user via the telephone, comprising:
instructions for creating a compliance program;
instructions for associating the compliance program with the user; and
instructions for executing the compliance program, the compliance program including one or more messages to be transmitted to the user via the telephone when a condition associated with the corresponding message is satisfied, each of the messages including medical advice or medical information corresponding to a medication or medical condition.
